(19) United States
(12) Patent Application Publication
(10) Pub. No.: US 2013/0066654 A1
(43) Pub. Date: Mar. 14, 2013

(54) Health-Related Information Management

(71) Applicant: Mary Thomason, West Jordan, UT (US)

(72) Inventor: Mary Thomason, West Jordan, UT (US)

(21) Appl. No.: 13/610,861

(22) Filed: Sep. 12, 2012

Related U.S. Application Data
(60) Provisional application No. 61/573,812, filed on Sep. 13, 2011.

(51) Int. Cl. G06Q 50/24

(52) U.S. Cl. 705/3

(57) ABSTRACT

This patent application relates to health-related information (HRI) management techniques for handling individual requests for HRI in a timely and compliant manner, and/or for providing HRI training in a timely and relevant manner. Complex requirements associated with certain types of protected HRI (PHRI) can thus be promptly applied to individual HRI requests to ensure compliance with these requirements.

### CROSS REFERENCE TO RELATED APPLICATION

This application claims the benefit of U.S. Provisional Application No. 61/573,812, filed Sep. 13, 2011.

### BACKGROUND

Determining what health-related information, if any, can be shared is a challenging problem facing entities such as hospitals, physicians, insurance companies, and the like. Often, these entities are subject to complex requirements intended to protect certain types of health-related information. For example, the privacy rules issued by the U.S. Department of Health and Human Services (HHS) to implement the Health Insurance Portability and Accountability Act of 1996 (HIPAA) established national standards intended to protect individuals' health information while still allowing this information to be shared in a manner that permits the provision of quality health care.

Given the complexity of these requirements, the number of requests for health-related information that such entities typically receive, and the myriad of possible responses, it may be impractical or even impossible for an entity to rely on a trained specialist to handle each such requests. However, the potential impact on an individual's privacy, steep potential fines, reputational harm, and other serious repercussions associated with violating these requirements makes compliance critical.

### SUMMARY

Health-related information (HRI) management techniques are described for handling individual requests for HRI (i.e., HRI requests) in a timely and compliant manner, and/or for providing HRI training in a timely and relevant manner. By implementing these techniques, complex requirements associated with certain types of protected HRI (PHRI) can be promptly applied to individual HRI requests to ensure compliance with these requirements. As a result, entities that are subject to these PHRI requirements (i.e., covered entities) can compliantly respond to individual HRI requests without having to provide a highly trained specialist to handle each such request.

In at least one embodiment, an HRI request associated with an individual of interest (IOI) can be received. For example, an employee of a hospital that is a covered entity might be asked to provide information about a patient's medical record, such as prescription drug data, diagnostic data, or lab test result data for instance. The requestor may or may not be employed or otherwise associated with the hospital. Other examples of receiving a request include receiving a request from the IOI to exercise a privacy right associated with the Health Insurance Portability and Accountability Act of 1996 (HIPAA).

In response to receiving the HRI request, contextual information associated with the request can be obtained. More particularly, contextual information that is relevant to determining, in light of applicable PHRI requirements, an authorized response to the HRI request can be identified, collected, assessed, and/or requested. Without limitation, contextual information might include information about the requestor, the request, the HRI, the IOI, and/or the receiver of the request.

Contextual information can be obtained in any suitable way. For example, in at least one embodiment an HRI decision framework of one or more interconnected HRI request response algorithms (i.e. step-by-step HRI request response protocol(s)) can be utilized to identify, collect, assess, and/or request contextual information based on the applicable PHRI requirements. In operation, this might include identifying and collecting contextual information, assessing the collected contextual information to identify other uncollected contextual information, and/or then collecting the uncollected contextual information.

Once at least some contextual information has been obtained, this information can be used to determine an authorized response to the HRI request and, in at least one embodiment, recommending the authorized response to a user. Determining the authorized response might include, for example, determining an authorized portion the requested HRI that can be compliantly disclosed to the requestor based on the contextual information and the applicable PHRI requirements. As used herein, an authorized portion of requested HRI can include all of the requested HRI, less than all of the requested HRI, or none of the requested HRI.

Alternatively or additionally, determining the authorized response might include determining one or more response actions to be taken in order to ensure compliance with the applicable PHRI requirements. A response action might include, for example, documenting some or all of the obtained contextual information and/or authorized portion.

The authorized response can be determined in any suitable way. For example, in at least one embodiment the HRI decision framework can be utilized to automatically determine the authorized response based on the contextual information and the applicable PHRI requirements.

In at least one embodiment, an HRI management tool can be implemented to handle HRI requests in a timely and compliant manner by at least in part automatically obtaining some or all of the contextual information and/or by at least in part automatically determining an authorized response. In at least one embodiment, the HRI management tool can be configured to utilize the HRI decision framework to accomplish this.

For example, the HRI management tool might be configured to interactively guide a user (e.g., the request receiver, requestor, etc.) to obtain (e.g., request, discover, collect, and/or input) relevant contextual information and/or automatically obtain (e.g., retrieve from electronic storage) the contextual information.

For example, the HRI management tool might be utilized to identify and collect new contextual information, identify other uncollected new contextual information applicable to determining the authorized response, and interactively request (e.g., prompt) some or all of the uncollected new contextual information from the user in an iterative manner. The user can thus interact with the HRI management tool by answering the requests and/or taking other steps associated with the authorized response. Alternatively or additionally, the tool might be utilized to automatically retrieve new contextual information from one or more locations where the information is stored.

Once at least some of the contextual information is obtained, the HRI management tool can then be utilized to automatically determine an authorized portion that can be disclosed and/or one or more response actions to be taken to ensure compliance with the applicable PHRI requirements.

In at least one embodiment, the HRI management tool can be implemented to provide HRI training in a timely (e.g., just-in-time) and relevant manner. In at least one embodiment, the HRI management tool can be configured to utilize the HRI decision framework to accomplish this.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements.

FIGS. 1-3 illustrate example techniques or methods that may be implemented in accordance with at least one embodiment.

FIG. 4 illustrates an example system in which the described techniques may be implemented, in accordance with at least one embodiment.

FIGS. 5-15 illustrate example interconnected HRI request response algorithms of an example HRI decision framework, in accordance with at least one embodiment.

### DETAILED DESCRIPTION

### Overview

Health-related information (HRI) management techniques are described for handling individual requests for HRI in a timely and compliant manner, and/or for providing HRI training in a timely and relevant manner. By implementing these techniques, complex requirements associated with certain types of protected HRI (PHRI) can be promptly applied to individual HRI requests to ensure compliance with these requirements. As a result, entities that are subject to these PHRI requirements (i.e., covered entities) can compliantly respond to individual HRI requests without providing a highly trained specialist to handle each such request.

In at least one embodiment, a request for HRI (i.e., HRI request) associated with an individual of interest (IOI) can be received. For example, an employee of a hospital that is a covered entity might be asked to provide (i.e., release or disclose) information about a patient's medical record, such as prescription drug data, diagnostic data, or lab test result data for instance. The requestor may or may not be employed or otherwise associated with the hospital. Other examples include receiving a request from the IOI to exercise a privacy right associated with the HRI, to report a breach or other event associated with the HRI, etc.

In response to receiving the HRI request, contextual information associated with the request can be obtained. More particularly, contextual information that is relevant to determining an authorized response to the HRI request, in light of applicable PHRI requirements, can be identified, collected, assessed, and/or requested. Without limitation, contextual information might include information about the requestor, the request, the HRI, the IOI, and/or the receiver of the request.

Contextual information can be obtained in any suitable way. For example, in at least one embodiment an HRI decision framework of one or more individual HRI request response algorithms (i.e. step-by-step HRI request response protocol(s)) can be utilized to identify, collect, assess, and/or request contextual information based on the applicable PHRI requirements. In operation, this might include identifying and collecting contextual information, assessing the collected contextual information to identify other uncollected contextual information, and/or then collecting the uncollected contextual information.

Once at least some contextual information has been obtained, this information can be used to determine an authorized response to the HRI request and, in at least one embodiment, recommending the authorized response to a user. Determining the authorized response might include for example, determining an authorized portion of the requested HRI that can be disclosed to the requestor based on the contextual information and the applicable PHRI requirements. As used herein, an authorized portion of requested HRI can include all of the requested HRI, less than all of the requested HRI, or none of the requested HRI. In other words, the authorized portion might not include the requested HRI, or might include some or all of the requested HRI.

Alternatively or additionally, determining the authorized response might include determining one or more response actions to be taken in order to ensure compliance with the applicable PHRI requirements. A response action might include, for example, documenting some or all of the obtained contextual information and/or the authorized portion that was disclosed.

The authorized response can be determined in any suitable way. For example, in at least one embodiment the HRI decision framework can be utilized to automatically determine the authorized response based on the contextual information and the applicable PHRI requirements.

In at least one embodiment, an HRI management tool can be implemented to handle HRI requests in a timely and compliant manner by at least in part automatically obtaining some or all of the contextual information and/or by at least in part automatically determining an authorized response. In at least one embodiment, the HRI management tool can be configured to utilize the HRI decision framework to accomplish this.

For example, the HRI management tool might be configured to interactively guide a user (e.g., the request receiver, requestor, etc.) to obtain (e.g., request, discover, collect, and/or input) relevant contextual information and/or to automatically obtain (e.g., retrieve from electronic storage relevant contextual information.

To accomplish this, in at least one embodiment the HRI management tool might automatically traverse one or more individual decision pathways of the individual request response algorithm(s) of the HRI decision framework based on obtained contextual information. The HRI management tool might stop at certain points along the pathway to solicit contextual information from the user and/or to provide contextual information to the user.

By automatically traversing one or more individual decision pathways, the HRI management tool can effectively utilize the HRI decision framework's interconnected HRI request response algorithms to identify, collect, assess, and/or request some or all of the contextual information at least in part automatically.

For example, the HRI management tool might be utilized to identify and collect new contextual information, identify other new uncollected contextual information applicable to determining the authorized response, and interactively request (e.g., prompt) some or all of the new uncollected contextual information from the user for in an iterative manner. The user can thus interact with the HRI management tool by answering the requests and/or taking other steps associated with the authorized response. Alternatively or additionally, the tool might be utilized to automatically retrieve new contextual information from one or more locations where the information is stored.

Once at least some of the contextual information is obtained, the HRI management tool can be utilized to automatically determine and authorized portion that can be disclosed and/or one or more response actions to be taken to ensure compliance with the applicable PHRI requirements.

To accomplish this, in at least one embodiment the HRI management tool might utilize the obtained contextual information to automatically traverse one or more individual decision pathways of the individual request response algorithm(s) to reach one or more actions, such as identifying an authorized portion and/or otherwise taking a measure to comply with applicable PHRI requirements.

In at least one embodiment, the HRI management tool can be implemented to provide HRI training in a timely (e.g., just-in-time) and relevant manner. In at least one embodiment, the HRI management tool can be configured to utilize the HRI decision framework to accomplish this.

For example, the HRI management tool might be configured to interactively examine or test (e.g., question) a user (e.g., a trainee) about relevant PHRI requirements and/or HRI request response actions. To accomplish this, in at least one embodiment the HRI management tool might automatically traverse one or more individual decision pathways of the individual HRI request response algorithm(s) of the HRI decision framework based on answers provided by the user.

Accordingly, in some training scenarios the user may be asked questions about a real or mock request for HRI and/or other types of questions intended to test the user's knowledge and provide practical training about HRI compliance, including about compliantly handling a particular type of HRI request for instance. Alternatively or additionally, the user may be exposed to individual HRI request response algorithms, or protocols, of the HRI decision framework in a variety of ways to provide them with training and knowledge. Additionally, in at least one embodiment details about the training (e.g., the HRI request response protocol(s) involved), user's test responses, etc.) can be recorded for further training-related purposes.

Multiple and varied implementations are described herein. Generally, any of the features/functions described with reference to the figures can be implemented using software, hardware, firmware (e.g., fixed logic circuitry), manual processing, or any combination thereof. The terms “module”, “tool”, and/or “component” as used herein may generally represent software, hardware, firmware, or any combination thereof. For instance, the terms “tool” and “module” can represent software code and/or other types of instructions that perform specified tasks when executed on a computing device or devices.

Generally, the illustrated separation of modules, tools or components and functionality into distinct units may reflect an actual physical grouping and allocation of such software, firmware, and/or hardware. Alternatively or additionally, this illustrated separation can correspond to a conceptual allocation of different tasks to the software, firmware, and/or hardware. Furthermore, it is to be appreciated and understood that the illustrated modules, tools, and/or components and functionality described herein can be located at a single site (e.g., as implemented by a computing device), or can be distributed over multiple locations (e.g., as implemented over multiple computing devices).

### HRI and PHRI

For purposed of this discussion, HRI can be considered any information related to an individual's health care. For example, HRI might include an individual's employee health record, personal health record, medical record, or a communicable disease report maintained by a health department for instance.

In some circumstances, certain types of HRI can be protected as PHRI. Without limitation, in at least one embodiment protected can refer to certain legal protections (e.g., requirements, restrictions, guidelines, safeguards, etc.) associated with disclosing the PHRI or otherwise responding to a request for the PHRI.

More particularly, these legal protections may restrict or otherwise dictate the portion (portion may be some, all, or none of the PHRI) of the PHRI that can be compliantly disclosed, who the portion can and/or cannot be disclosed to, when and/or for what purpose the PHRI can be disclosed, how the PHRI can be disclosed, and/or what other action (if any) must and/or may be taken in response to a request for the PHRI and/or a disclosure of the portion of the PHRI. For example, before disclosing PHRI of a minor that is protected by 42 CFR Part 2, the minor's signature should be obtained on an authorization form in addition to the minor's personal representative.

One example of PHRI is health information that is protected under the HIPAA privacy rules as protected health information (PHI). These rules might include requirements that provide one or more legal protections for the PHI. PHI can be considered any information related to an individual's past, present, or future health care, the provision of that care, or the payment of that care. Under these HIPAA privacy rules, health plans, health care clearinghouses, and health care providers are defined as covered entities that are responsible for complying with the protections, or safeguards, provided for PHI under these rules.

Additional protection of PHI can be provided under other laws and rules, such as under Health Information Technology for Economic and Clinical Health (HITECH) or the federal law that protects the records of drug and alcohol treatment programs (42 CFR Part 2) for instance. However, in addition to or alternative PHI, it is to be appreciated and understood that PHRI can include one or more other types of HRI.

Laws and rules that protect PHRI, including PHI, can be complex. Contextual information about the circumstances associated with a particular request for PHRI can determine which particular response, of a number of possible responses, is the authorized compliant response.

For example, an IOI may request an amendment to an IOI's records, and an authorized response can be determined based on contextual information that describes the circumstances associated with that particular request. The authorized response might, or might not, include amending the IOI's records and/or taking other one or more other response actions such as corresponding with the IOI and/or requestor within a certain period of time for instance.

As another example, depending on the particular circumstances associated with a request for HRI, some authorized portions of the requested HRI might be able to be disclosed without obtaining the IOI's consent, while other authorized portions might require the IOI's consent.

As yet another example, some PHRI protections require that in certain circumstances an IOI has a right to request a listing, or log, of some or all of the PHRI disclosures about that IOI that a requestor has provided for up to six years after the disclosure of the PHRI occurred. In at least some circumstances, the log must identify contextual information about the requestor and the disclosed PHRI.

### Example HRI Request Response Technique or Method

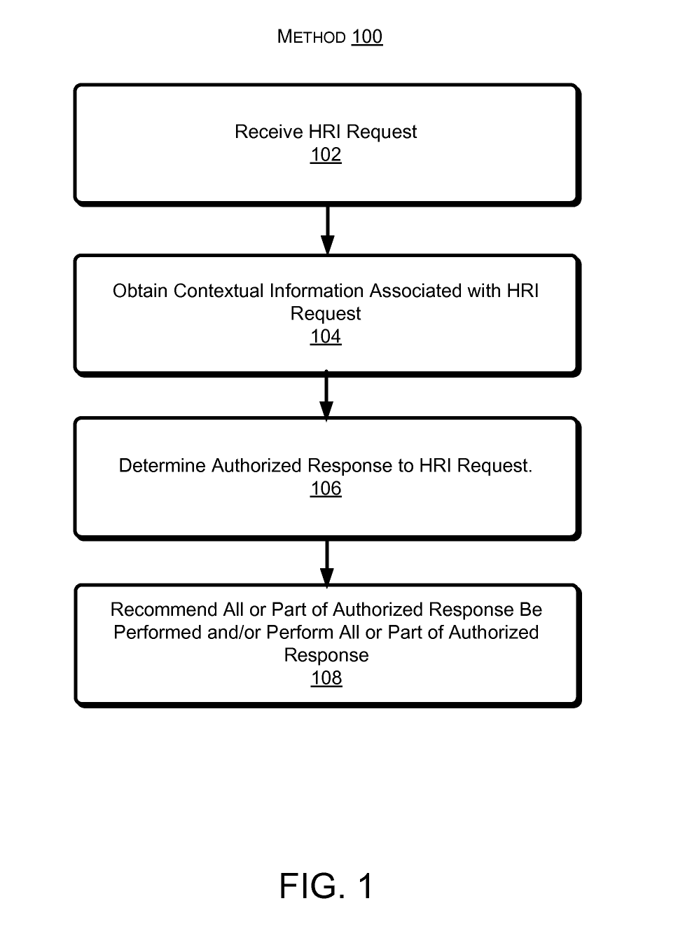

FIG. 1 illustrates a flowchart of a technique or method 100 that is consistent with at least one implementation of the described HRI management techniques. For ease of discussion, the technique or method 100 will be described in the context of an implementation that includes a receiver of an HRI request that is subject to various protections afforded PHRI, and is aware that they are responsible for ensuring that these protections are met. An example of such a receiver might be a covered entity, as described above and as defined by the HIPAA privacy rules.

However, it is to be appreciated and understood that in at least implementation of the described HRI management techniques, it may be uncertain to the receiver at the time an HRI request is received whether or not the receiver is responsible for ensuring that PHRI protections are met. In such implementations, the technique or method might therefore additionally include determining whether the receiver is responsible for ensuring that PHRI protections are met.

At block 102, an HRI request can be received. The requested HRI might be about a particular 101 and may or may not include PHRI about that IOI. Furthermore, the request might be received from the IOI, or from a third party that may or may not be associated with the IOI and/or receiver. As noted above, in this example, the receiver of the HRI request is subject to various protections afforded PHRI, and is aware that they are responsible for ensuring that these protections are met (e.g., as a covered entity).

In at least one embodiment, the request can be received by an individual directly that may utilize a tool, such as an HRI management tool for instance, to handle some or all of the request automatically in a timely and compliant manner. Alternatively or additionally, some or all of the request might be received. and the individual might utilize printed decision flow-sheets, protocols, checklists or other reference material provided by the HRI management tool. In at least one embodiment, the HRI management tool can be configured to utilize the HRI decision framework to accomplish this.

At block 104, contextual information associated the HRI request can be obtained. As noted above, contextual information can be any type of information that is relevant to determining an authorized response to the HRI request. Without limitation, this can include information about: the HRI being requested, requestor, the request, the HRI, the IOI, and/or the receiver of the request.

For example, contextual information about the requested HRI, such as the content of the requested HRI, can be applicable to making determining an authorized response. For instance, the requested HRI might include at least some content that is protectable as PHRI, such as PHI for example. More particularly, as explained above, HRI related to an individual's past, present, or future health care, the provision of that care, or the payment of that care can be considered PHI.

In some circumstances, determining whether or not the requested HRI includes PHRI might be based—at least in part—on other contextual information associated with the HRI request. For example, information about and/or collected from the requestor, IOI, and/or the receiver might be relevant to whether the requested HRI related to the individual's past, present, or future health care, the provision of that care, or the payment of that care.

As another example, contextual information about whether or not the requestor is the IOI, or a relative or representative of the IOI, can be applicable to determining whether or not certain PHI protections, or safeguards, are applicable and if so, how they should be accounted for in an authorized response. Furthermore, the requestor's reason for making the HRI request, their intended use of the HRI, and/or their role, if any, with respect to the IOI's health care and/or the HRI can also be applicable to making determining an authorized response.

The applicability of certain individual privacy rules and other PHRI safeguards can depend upon whether or not a disclosure authorization is provided, and if so what the content of such an authorization is. Therefore, as yet another example, contextual information about whether or not the HRI request includes a disclosure authorization (e.g., from the IOI), and the nature of the authorization in light of the requestor and/or intended use of the HRI can also be applicable to determining an authorized response.

As noted above. contextual information can be obtained in any suitable way. For example, contextual information can be identified, collected, assessed, and/or requested from the HRI request, from information available to the receiver, from the requestor, and/or from any other suitable source. For example, in some circumstances contextual information that has not yet been collected (i.e. uncollected contextual information) might be identified based on identified and collected contextual information. In at least one embodiment, such uncollected contextual information can be requested from the requestor, receiver, and/or any other suitable source.

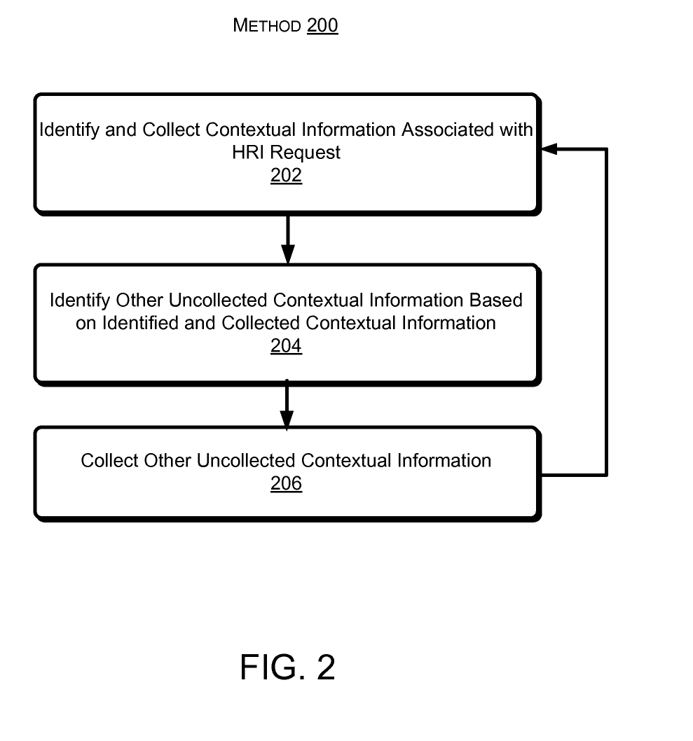

As one practical example of how contextual information can be obtained (e.g., in accordance with block 104), consider the flowchart of a technique or method 200 illustrated in FIG. 2 that is consistent with at least one implementation of the described HRI management techniques.

At block 202, contextual information associated with an HRI request (e.g., the HRI request of the technique or method 100) can be identified and collected. As noted above, this collected contextual information can be relevant to determining an authorized response to the HRI request. For example, contextual information about the identity of the HRI requestor, the requested HRI, and/or the IOI may often be available at the time the HRI request is received.

In at least one embodiment, this might be accomplished at least in part automatically by automatically traversing one or more individual decision pathways of the individual request response algorithm(s) of the HRI decision framework to identify and/or collect the contextual information. For example, a user might be interactively guided to obtain (e.g., request, discover, collect, and/or input) the contextual information. Alternatively or additionally, the contextual information might be automatically obtained (e.g., retrieved from electronic storage).

At block 204, other contextual information (if any) that is relevant to determining the authorized response, and that has not yet been collected (i.e. uncollected contextual information), can be identified based on the identified and collected contextual information. In other words, the contextual information identified and collected at block 202 can be utilized (e.g., assessed) to identify other relevant uncollected contextual information. Without limitation, the other uncollected contextual information can include additional and/or updated relevant contextual information such as corrected, more detailed, and/or more current contextual information.

In at least one embodiment, this might be accomplished at least in part automatically utilizing the contextual information identified and collected at block 202 (i.e., the collected contextual information). More particularly, this collected contextual information might be utilized to automatically traverse along one or more individual decision pathways of the individual request response algorithm(s) of the HRI decision framework to identify and/or collect the other uncollected contextual information.

For example, a user might be interactively guided to obtain (e.g., request, discover, collect, and/or input) the other uncollected contextual information. Alternatively or additionally, the other uncollected information might be automatically obtained (e.g., retrieved from electronic storage).

at block 206, the other uncollected contextual information can be collected. In at least one embodiment, this can include requesting the information from one or more suitable sources. Without limitation, examples of requesting the other uncollected contextual information might include automatically prompting a user of a tool such as the above-described HRI management tool, providing a printed and/or electronic decision flow-sheet or other type of document that shows the request, and/or providing an electronic or audio request to one or more suitable individuals (e.g., the user).

Note that once some or all of the other uncollected contextual information has been collected at block 206, that information can be considered identified and collected contextual information. Accordingly, as shown in FIG. 2, this collected and identified contextual information can again be identified and collected at block 202. As such, one or more of steps 202, 204, and 206 can be implemented in an iterative manner any number of times until a final set of contextual information is obtained.

In at least one embodiment, the HRI decision framework of one or more interconnected HRI request response algorithms can be utilized to perform some or all of the technique or method 200 based on applicable PHRI requirements. For example, a tool such as the above-described HRI management tool, might be configured to utilize the HRI decision framework to identify, collect, assess, and/or request some or all of the contextual information automatically.

Referring again to FIG. 1, once the contextual information is obtained, at block 106 an authorized response can be determined based on the obtained contextual information and/or applicable PHRI requirements. Determining an authorized response can include determining an authorized portion of the requested HRI in the HRI request that can be disclosed to the requestor based on the contextual information and the applicable PHRI requirements. A portion of requested HRI might include all of the requested HRI, less than all of the requested HRI, or none of the requested HRI.

Alternatively or additionally, determining the authorized response can include determining one or more actions to be carried out in order to comply with the applicable PHRI requirements.

For example, some or all of the requested HRI might include information protected under HIPAA as PHI. Based on the contextual information and one or more applicable PHI requirements, it can be determined what part of the PHI (i.e., information protected under HIPAA), if any, can be compliantly disclosed to the requestor. Additionally, one or more actions might be identified that need to be carried out in order for the applicable PHI requirement(s) to be met.

Consider, for instance, a practical scenario where a portion of the requested HRI is determined to include HRI that is not protected as PHRI based on the circumstances (as described by the contextual information) and applicable requirements (if any), and thus may be compliantly disclosed to the requestor. For instance an employee health record may be accessed by an employer's human resources department. As another instance, a laboratory test confirming a communicable disease in many cases must be disclosed to a public health entity.

Continuing, in this example scenario assume another portion of the requested HRI is determined to include PHRI (e.g., PHI) that may not be compliantly disclosed to the requestor under the circumstances. A third portion of the requested HRI, however, is determined to include PHRI (e.g., PHI) that may be compliantly disclosed to the requestor under the circumstances and/or if certain additional response actions are taken by the requestor, receiver, IOI, or other third party. A response action might include, for example, verifying and documenting the intended use of the requested HRI, verifying and documenting the requestor's identity, documenting some or all of the obtained contextual information and/or the disclosure of the authorized portion, etc.

In this example scenario, note that the authorized response can include the non-PHRI and PHRI portions of the requested HRI that may be compliantly disclosed under the circumstances. Additionally, the authorized response can include the additional response actions that need to be taken (if any) by the requestor, receiver, IOI, or other third party.

Also note that in accordance with the described HRI management techniques, individual response actions may be determined and/or carried out (e.g., as a prerequisite to continuing and/or disclosing the authorized portion) at any time upon or after receiving an HRI request.

For example, in some circumstances a part of the authorized response can be determined based at least in part on contextual information that has already been collected. Additional other uncollected contextual information can then be identified, requested, and collected. An additional part of the authorized response can then be determined based at least in part on the additional contextual information. Again, this additional part of the authorized response might include one or more response actions and/or the authorized portion of the requested HRI. This iterative interactive process may be repeated any number of times until a complete authorized response has been determined.

Alternatively, in at least some circumstances a complete authorized response can be determined at a single time based on collected contextual information.

In at least one embodiment, the HRI decision framework of one or more HRI interconnected request response algorithms can be utilized to determine the authorized response. For example, a tool such as the above-described HRI management tool might be configured to utilize individual request response algorithms of the framework.

More particularly, by automatically traversing along one or more individual decision pathways of individual HRI interconnected request response algorithms based on collected contextual information, the authorized portion of requested HRI and/or individual response actions (if any) that need to be performed can be determined. By virtue of the tool and this framework, collecting this contextual information and/or carrying out one or more of the response actions (if any) can be performed in an iterative and interactive manner that mitigates the risk of disclosing requested HRI non-compliantly.

Finally, at block 108 all or part of the authorized response can be recommended to be performed and/or can be performed. In other words, a recommendation can be made (e.g., to a user and/or the receiver) to perform at least part of the authorized response, and/or at least part of the response can be performed (e.g., automatically).

For example, one or more authorized portions determined at block 106 can be manually and/or at least in part automatically disclosed to the requestor. Alternatively or additionally, one or more actions determined at block 106 can be performed manually and/or at least in part automatically at any time during and/or after the implementation of technique or method 100.

### Example HRI Training Technique or Method

Recall that by implementing the described HRI management techniques, timely and relevant HRI training (e.g., just-in-time training) can be provided. Furthermore, this training can be documented and tracked in order to meet various government and/or private training requirements and standards.

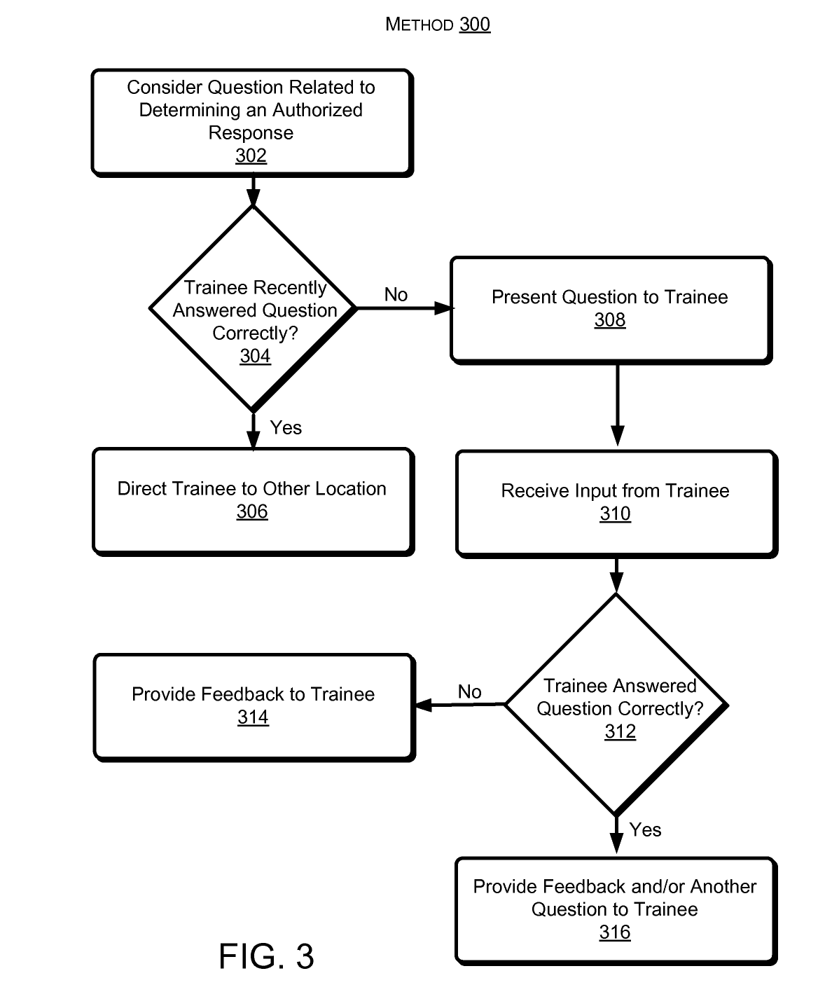

Accordingly, FIG. 3 illustrates a flowchart of a technique or method 300 for providing timely and relevant HRI training that can be implemented in accordance with at least one embodiment. In at least one embodiment, some or all of the blocks, or steps, of technique or method 300 can be performed at least in part automatically by a tool such the HRI management tool described above.

Furthermore, in at least one embodiment the HRI management tool can be configured to utilize the HRI decision framework to accomplish this. More particularly, as described above the HRI management tool can be implemented to provide HRI training in a timely (e.g., just-in-time) and relevant manner by utilizing the HRI decision framework to interactively examine or test (e.g., question) a user about relevant PHRI requirements and/or HRI request response actions. To accomplish this, in at least one embodiment the HRI management tool can automatically traverse along one or more individual decision pathways of the individual HRI request response algorithm(s) of the HRI decision framework based on answers provided (e.g., inputted) by the user.

At block 302, a question related to determining an authorized response to an HRI request can be considered for presentation to an individual, such as a user of the HRI management tool for instance. For ease of discussion, the individual will be referred to herein as a trainee. In at least one embodiment, the question might correspond to one or more particular HRI request response algorithms.

At block 304, a determination can be made whether or not the trainee has recently answered the question. In at least one embodiment, a defined discrete period, or length, of time (e.g., from the date/time the question is considered at block 302) can be set as a threshold for defining recently. In other words, the determination of whether or not the trainee has recently answered the question can be based in part on whether or not the trainee correctly answered the question previously within the defined discrete period, or length, of time.

If it is determined at block 304 that the trainee did recently answer the question correctly (“Yes”), the question may not be presented (e.g., displayed) to the trainee and instead at block 306 the trainee can be directed to a location where additional questions, training opportunities, and/or resources are available. For example, in the context of the HRI management tool, the location might be a main training menu or other display.

If it is determined at block 304 that the trainee did not recently answer the question correctly (“No”), at block 308 the question can be presented to the trainee. At block 310, input can then be received from the trainee. The input might, for example, include the trainee's answer to the question and/or other information.

At block 312 a determination can then be made whether or not the trainee answered the question correctly based upon the input received at block 310. In at least one embodiment, this determination can be made by comparing input from the trainee (e.g., the trainee's answer to the question) to the correct answer to the question. For example, the correct answer might be represented in and/or retrieved from a particular HRI request response algorithm of the HRI decision framework.

Continuing, if it is determined at block 312 that the trainee did not answer the question correctly (“No”), at block 314 feedback about this determination can be presented to the trainee. This feedback can include, for example, a message to the trainee and/or another entity, and/or access to training materials (e.g., a relevant HRI request response algorithm, a fact sheet associated with the correct answer, links to additional training resources, etc.). In at least one embodiment, the determination at block 312 and/or feedback at block 314 can be documented (e.g., recorded with a time stamp) for various compliance and/or recordkeeping requirements.

If, however, it is determined at block 312 that the trainee did answer the question correctly (“Yes”), at block 316 feedback about this determination and/or another question can be presented to the user. This feedback can include, for example, a message to the trainee and/or another entity, and/or access to training materials (e.g., a relevant HRI request response algorithm, a fact sheet associated with the correct answer, links to additional training resources, etc.).

For example, in at least one embodiment another question in the HRI request response algorithm associated with the question presented at block 308 can be presented to the trainee. In at least one embodiment, the determination at block 312 and/or feedback at block 314 and/or block 316 can be documented (e.g., recorded with a time stamp) for various reasons such as compliance, future training, and/or recordkeeping requirements for instance.

### Example System

The HRI management techniques described herein can be implemented in any suitable way. For example, in at least one embodiment these techniques, including the described HRI management tool, may be implemented at least in part by a HRI response system. This HRI response system may include, for example, an HRI request module, HRI contextual information module, HRI response module, and/or an HRI training module.

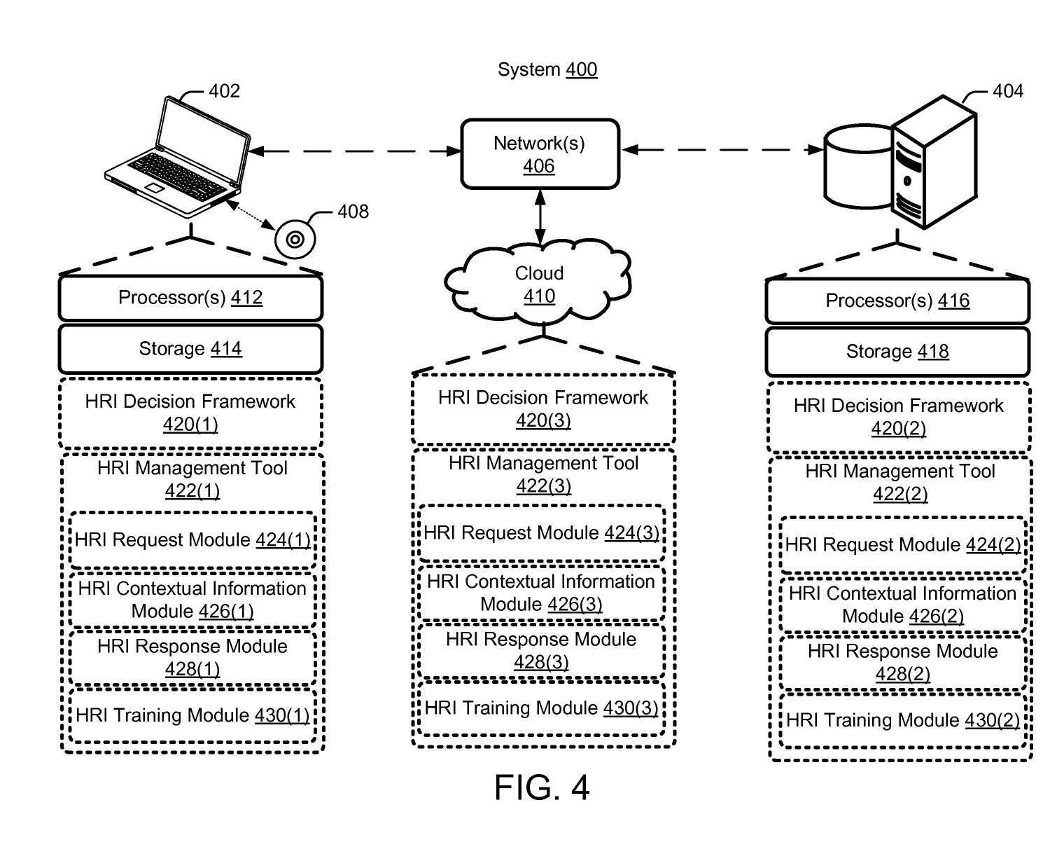

To facilitate the readers' understanding of such an example system, FIG. 4 illustrates an example system 400 which may be implemented in accordance with at least one embodiment. In this example, the system 400 includes multiple computing devices, represented here as computing devices 402 and 404. These computing devices can function in a stand-alone or cooperative manner to implement the described HRI management techniques

Here in this example, the computing device 402 is shown embodied as a portable laptop computing device. Computing device 404, in turn, is shown embodied as a server computing device. However, this is not intended to be limiting, and it is to be appreciated and understood that the example system 400 can include any number and type(s) of computing devices.

In this regard, the term “computing device”, as used herein, can mean any type of device or devices having some amount of processing capability. Examples of computing devices can include traditional computing devices, such as personal computers (desktop, portable laptop, etc.), cell phones, server computing devices, tablets, smart phones, personal digital assistants, or any of various ever-evolving or yet to be developed types of computing devices.

Computing devices 402 and 404 can indirectly and/or directly exchange data via one or more network(s) 406 and/or by any other suitable means, such as via an external storage 408 for instance. Without limitation, the network(s) 406 can include one or more local area networks (LANs), wide area networks (WANs), the Internet, and/or the like. Examples of the external storage 408 can include optical storage devices (e.g., CDs, DVDs etc.) and flash storage devices (e.g., memory sticks or memory cards), among others

Additionally or alternatively, the computing devices 402 and/or 404 can exchange data with other resources associated with the cloud 410, for example via the network(s) 406. As used herein, the cloud 410 refers to computing-related resources/functionalities that can be accessed via the network(s) 1706, although the location of these computing resources and functionalities may not be readily apparent.

Here, computing devices 402 and 404 can each include a processor(s) (i.e., central processing unit(s)) and storage. More particularly, here the computing device 402 includes processor(s) 412 and storage 414. Similarly, the computing device 404 includes processor(s) 416 and storage 418. The processor(s) 412 and 416 can execute data in the form of computer-readable instructions to provide the functionality described herein. Data, such as computer-readable instructions, can be stored on the storage 414 and/or 418. The storage 414 and/or 418 can include one or more of volatile or non-volatile memory, hard drives, optical storage devices (e.g., CDs, DVDs etc.), or the like.

The devices 402 and 404 can also be configured to receive and/or generate data in the form of computer-readable instructions from one or more other storages, such as the external storage 408 for instance. The computing devices may also receive data in the form of computer-readable instructions over the network(s) 406 that are then stored on the computing device(s) for execution by the processor(s).

As used herein, the term “computer-readable media” can include transitory and non-transitory instructions. In contrast, the term “computer-readable storage media” excludes transitory instances. Computer-readable storage media can include “computer-readable storage devices”. Examples of computer-readable storage devices include volatile storage media, such as RAM, and non-volatile storage media, such as hard drives, optical discs, and flash memory, among others.

Recall that in at least one embodiment, an HRI decision framework can be utilized to implement at least some of the described HRI management techniques. Also recall that in at least one embodiment, an HRI management tool can be configured to utilize the HRI decision framework to accomplish this. Accordingly, in this example the computing device 402 is shown as being configured to implement at least part of an HRI decision framework 420 (i.e., as HRI decision framework 420(1)) and at least part of an HRI management tool 422 (i.e., as HRI management tool 422(1)).

The computing device 404, in turn, is also shown in this example as being configured to implement at least part of the HRI decision framework 420 (i.e., as HRI decision framework 420(2)) and at least part of the HRI management tool 422 (i.e., as HRI management tool 422(2)). Additionally, at least part of the HRI decision framework 420 and/or at least part of the HRI management tool 422 is shown in this example as being implementable by one or more distributed computing resources of the cloud 410 (i.e., as HRI decision framework 420(3) and/or as HRI management tool 422(3)).

By leveraging (e.g., utilizing) the functionality of the HRI decision framework 420, the HRI management tool 422 can be implemented to automatically perform some or all of the described techniques and functionalities, such as all or part of the methods described above relative to FIGS. 1-3 for instance. To accomplish this, the HRI management tool 422 can include any number of configurable modules.

Accordingly, in this example the HRI management tool 422 can include an HRI request module 424, HRI contextual information module 426, HRI response module 428, and an HRI training module 430. Note that functionality provided by the HRI management tool 422 can be provided by any combination of these modules. Furthermore, in at least one embodiment, the HRI management tool 422 may include other modules that, for the sake of brevity, are not shown in this example.

In at least one embodiment, the HRI request module 424 can be configured to receive an HRI request in a variety of ways. For example, a user of the HRI management tool 422 might input the HRI request into the HRI management tool 422 via an interface (e.g., user interface). The user might be: the HRI requestor, the receiver that has received the HRI request, a trainee, or any other entity. Alternatively or additionally, the HRI request might be received vie the interface without any user action. For example, the HRI request might be directly received electronically from the HRI requestor or other entity.

In at least one embodiment, the HRI request module 424 might be configured to respond to receiving the HRI request in a particular way. For example, without limitation, the HRI request module 424 might notify a user or other entity, send a confirmation of the response, and/or automatically trigger another module of the HRI management tool 422 (e.g., the HRI contextual information module 426).

In at least one embodiment, the HRI request module 424 can be configured to utilize the HRI decision framework 420. For example, based on one or more HRI request response algorithms of the framework, the HRI request module 424 might initially request additional information, such as contextual information (e.g. from the requestor and/or user), soon after receiving the HRI request.

Consider, for instance, an HRI request that is incomplete and/or that is from an unidentified requestor. Providing a timely follow-up request for additional information to address these concerns might be advantageous with respect to obtaining that information.

Continuing, the HRI contextual information module 426, in turn, can be configured to perform some or all of the functions associated with obtaining contextual information applicable to determining an authorized response to the HRI request. For example, as discussed above with respect to the technique or method 200 and/or 300, this might include identifying, collecting, assessing, and/or requesting contextual information from the HRI request, from information available to the receiver, from the requestor, and/or from any other suitable source.

The HRI response module 428, in turn, can be configured to perform some or all of the functions associated with determining the authorized response, as discussed above with respect to the technique or method 200 and/or 300 for instance. In this regard, in at least one embodiment functionality of the HRI response module 428 can be coordinated closely with the functionality of the HRI contextual information module 426.

For example, as noted above, contextual information can be obtained, and various the authorized response can be determined and/or carried out at any time in an iterative manner upon or after receiving an HRI request. For instance, in some circumstances a part of the authorized response can be determined based at least in part on contextual information that has already been collected. Additional other uncollected contextual information can then be identified, requested, and collected. An additional part of the authorized response can then be determined based at least in part on the additional contextual information.

In this example, the HRI training module 430 can be configured to utilize the HRI decision framework 420 to implement timely and relevant training, such as in accordance with the technique or method 300 described above for instance.

### Example HRI Decision Framework Implementation

Recall from above that an HRI decision framework, such as HRI decision framework 420, can be utilized to implement at least some of the described HRI management techniques above. More particularly, one or more individual HRI request response algorithms, or step-by-step HRI request response protocols, can be followed based on obtained contextual information.

In at least one embodiment, one or more individual decision pathways through the individual request response algorithm(s) of the HRI decision framework can be determined, and thus defined, by individual questions in the algorithms, and how the individual questions are answered to arrive at one or more specific authorized response components. These authorized response components can form all or part of an authorized response.

In other words, an individual decision pathway through the framework leading to all or part of the authorized response can be defined by individual questions and their respective individual answers. These individual answers, in turn, can be based on obtained contextual information that is applicable to determining the authorized response.

In at least one embodiment, a tools such as the HRI management tool described above can be configured to automatically traverse along one or more individual decision pathways through the individual request response algorithm(s) of the HRI decision framework. This traversal can be based on individuals answers that can be made automatically based on obtained contextual information

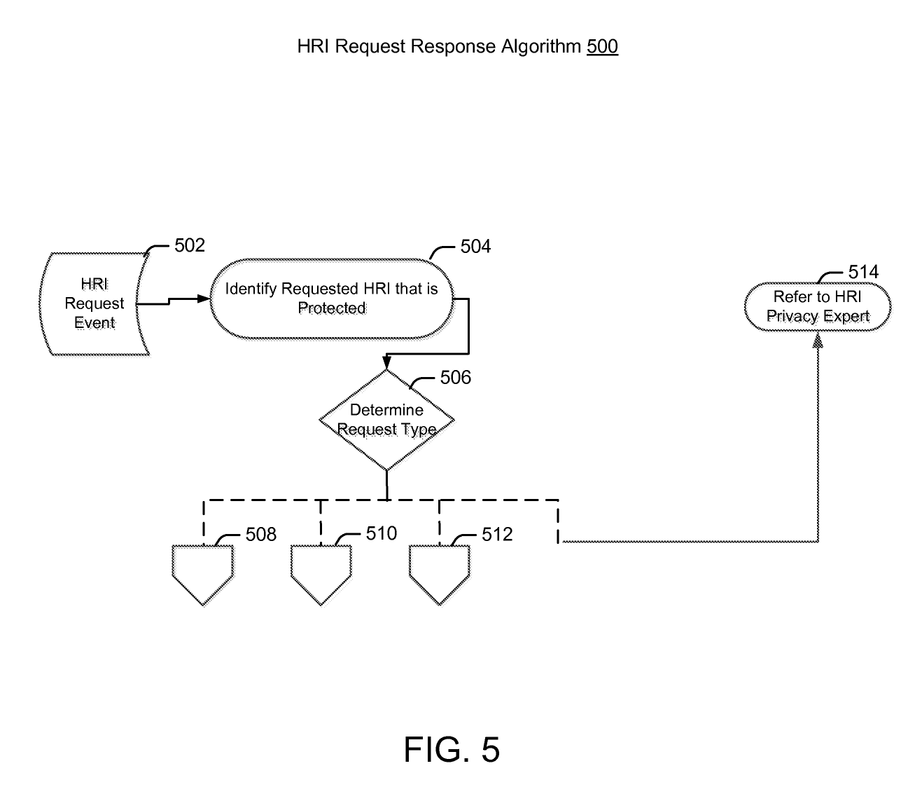

To assist the reader in understanding the described HRI management techniques, FIGS. 5-15 illustrate example interconnected HRI request response algorithms of an example HRI decision framework that can be utilized to implement an HRI management tool, in accordance with at least one embodiment.

For discussion purposes, these example HRI request response algorithms are presented and described in the context of PHRI that is PHI. However, it is to be appreciated and understood that this is not intended to limiting and the techniques and principles associated with these example algorithms are applicable to any type of PHRI.

Note that to facilitate the reader's understanding of how the example HRI decision framework can be utilized to implement an HRI management tool, individual example HRI request response algorithms of this framework are presented. In at least one embodiment, one or more of Individual actions of one or more of the individual example HRI request response algorithms can be performed at least in part automatically by the HRI management tool.

Alternatively or additionally, one or more of the Individual actions of one or more of the individual example HRI request response algorithms can be performed at least in part manually by a user of the HRI management tool—optionally with the automated assistance of the HRI management tool. Accordingly, these individual actions can be designated as user and/or system actions.

Note that in at least one embodiment, individual user and/or system actions in an example HRI request response algorithm can be considered individual steps in a technique or method that is represented at least in part by the example HRI request response algorithm.

Also note that at any one or more points in an example HRI request response algorithm, the user might be provided with assistance (e.g., guidelines, guidance documents, definitions, training, etc.). For instance, readily available (e.g., just-in-time) and relevant training and/or other assistance can be provided based on a determination that is made and/or on a response action that is performed.

FIG. 5 illustrates an example HRI request response algorithm 500 associated with initially receiving a HRI request event about an IOI. More particularly, an HRI request at user and/or system action 502 can be associated with an HRI request. For example, the user of the HRI request tool may be prompted by the IOI, presenting with a request in person, may receive a written request for HRI, or receive a telephone request for HRI. The user then can initiate the HRI request event in response to receiving the HRI request.

In response to the HRI request event 502, HRI that is unprotected (i.e., not protected as PHI) (if any) can be identified and authorized for release (e.g., as an authorized portion), as depicted by user and/or system action 504. In other words, for the purposes of the example HRI decision framework, HRI that is not protected can be determined to be an authorized portion. This identified unprotected HRI can be considered contextual information.

To accomplish this, in at least one embodiment the user can be presented with a system prompt that requests that the user identify the unprotected HRI (if any) that is not protected. The user can also be automatically provided with assistance to assist them in accomplishing this. Documents or other items that can provide such assistance can be considered contextual information. Alternatively or additionally, some or all the HRI that is not protected can be identified automatically (e.g., by the HRI management tool).

For the requested HRI that is protected as PHI, a determination at user and/or system action 506 can be made as to what type of PHI request has been received. To accomplish this, in at least one embodiment the user can be presented with a system prompt that requests that the user determine the request type. The user can also be automatically provided with assistance (e.g., guidelines, definitions, etc) to assist them in accomplishing this. For example, the user could be given the four possible choices, as described below, to choose from and accompanying descriptions of each type. Alternatively or additionally, the request type can be determined automatically (e.g., by the HRI management tool).

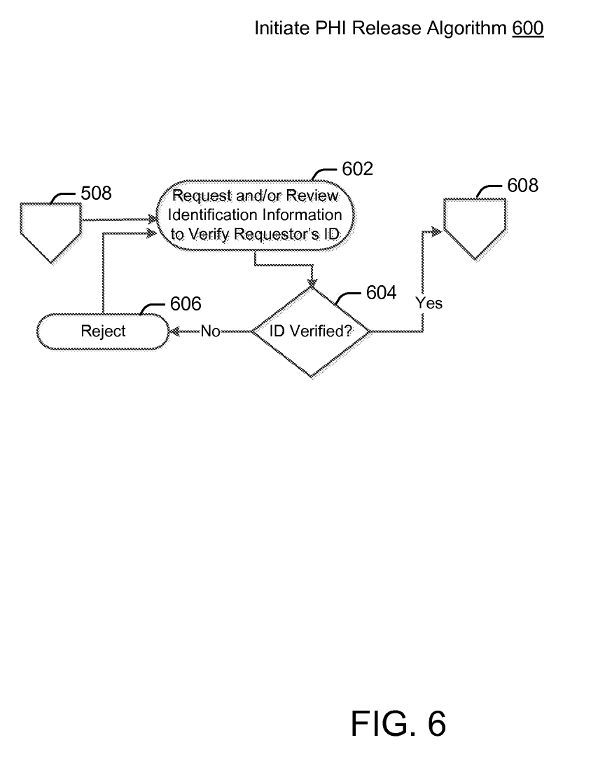

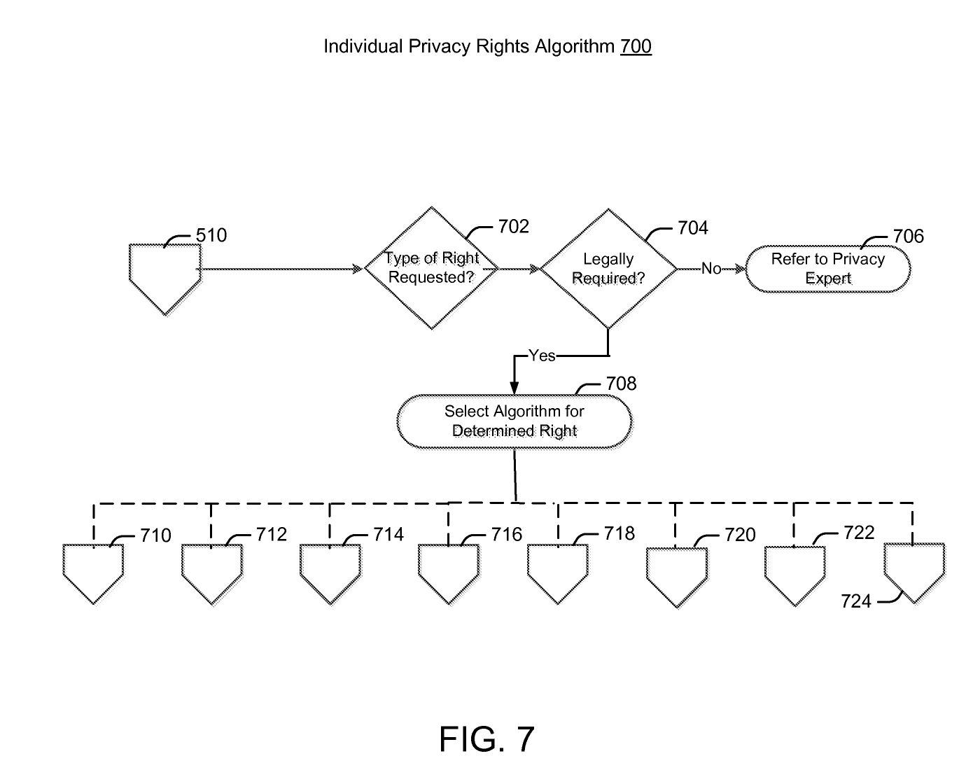

If the PHI request type is a disclosure request from someone other than the IOI or their personal representative, an initiate PHI release algorithm 600 can be applied and followed, as represented by algorithm identifier 508 which links to FIG. 6. If the HRI request type is from the IOI or their personal representative, an individual privacy rights algorithm 700 can be applied and followed, as represented algorithm identifier 510 which links to FIG. 7

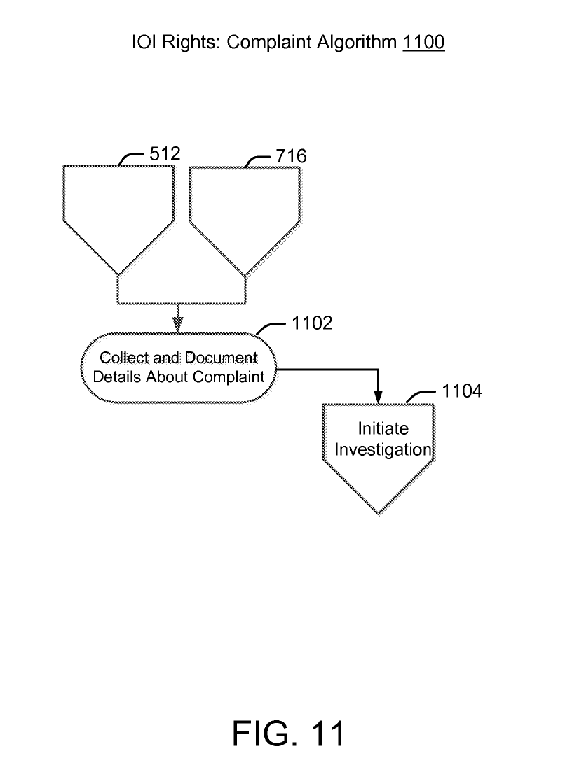

Continuing, if the request type is a complaint or report of a possible PHI compliance violation, an IOI rights: complaint algorithm 1100 can be applied and followed, as represented algorithm identifier 512 which links to FIG. 11. Finally, if the request type is a type other than the above-described types, at user and/or system action 514 the HRI request can be referred to a privacy expert (e.g., privacy officer) for a more in depth investigation and analysis. In such circumstances, a notification to make such a referral and/or contact information for such a privacy expert might be automatically presented to the user.

Referring to FIG. 5, for purposes of discussion assume that the HRI request associated with the HRI request event 502 is a disclosure request from someone other than the IOI or their personal representative. Accordingly, the initiate PHI release algorithm 600 can be applied and followed, as illustrated in FIG. 6

More particularly, at user and/or system action 602, identification information (e.g., valid identification documents) can be requested and/or reviewed to verify the requestor's identity (ID). For example, the user can be prompted to request and/or review such information. In at least one embodiment, the user might be provided with one or more guidance documents, such as a policy, procedure, guide, and/or other type of informational document to assist them in accomplishing this. Alternatively or additionally, the requestor's identity might be validated at least in part automatically by the HRI management tool. In at least one embodiment, a guidance document might be utilized to accomplish this.

To assist the reader's understanding, Table 1 provides one example of a guidance document that might be utilized to accomplish verifying the requestor's ID at user and/or system action 602.

TABLE 1
Example Guidance Document

```
The following can be used as ways to verify the identity of individuals or
entities:
  known individual
  facility workforce
  individual provides key information (spelling of name, birth date,
  account number, address)
  request on letterhead
  photo ID
  badge or identification as government agent
  legal document
This policy demonstrates compliance with 45 CFR §145.514 (Verification)
```

At user and/or system action 604, if the requestor's identity cannot be verified (“No”), at user and/or system action 606 the PHI request can be rejected. In at least one embodiment, at the user and/or system action 602, identification information can again be requested and/or reviewed to verify the requestor's ID. This can be performed iteratively any number of times until the requestor's ID is verified or until it is determined that the requestor's ID cannot be verified.

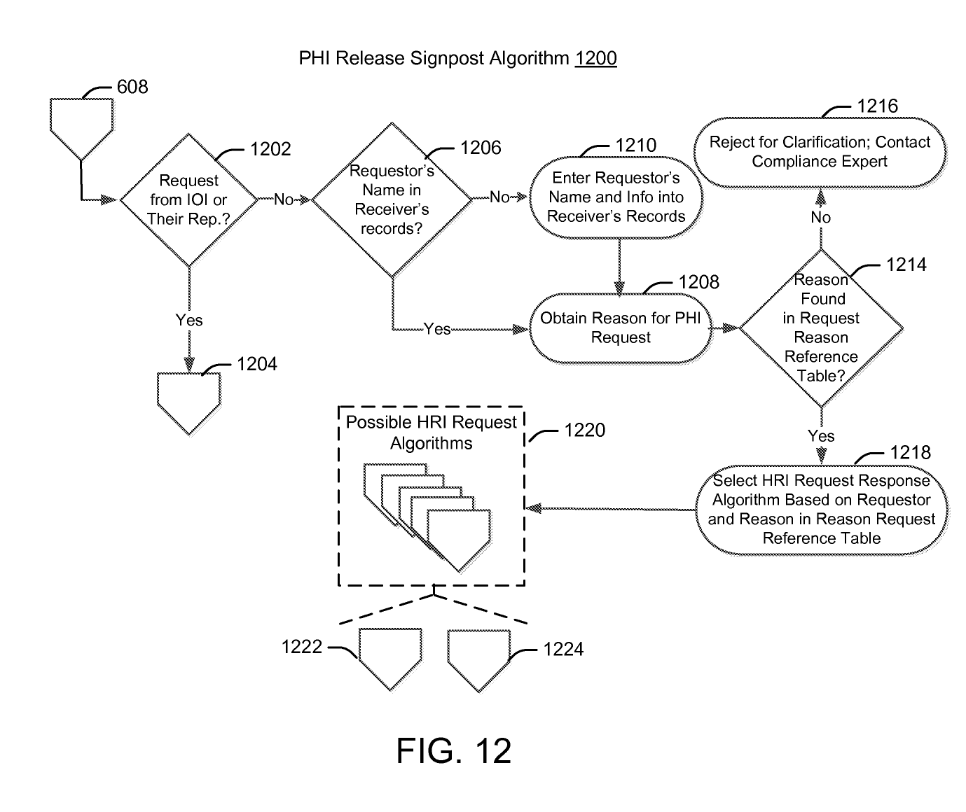

At user and/or system action 604, if the requestor's identity can be verified (“Yes”), a PHI release signpost algorithm 1200 can be applied and followed, as represented at algorithm identifier 608 which links to FIG. 12. For ease of discussion, the PHI release signpost algorithm 1200 will be described further below.

Referring to FIG. 5 again, for purposes of discussion, now assume that the PRI request type associated with the HRI request event 502 is from the IOI or their personal representative. Accordingly, the individual privacy rights algorithm 700 can be applied and followed, as illustrated in FIG. 7

Referring to FIG. 7, for purposes of discussion assume that the HRI request type is from the IOI or the IOI's personal representative and can pertain to an individual privacy right. At user and/or system action 702 a determination can be made as to what type of privacy right is being requested. To accomplish this, in at least one embodiment the user can be presented with a system prompt that requests that the user determine the HRI rights type. The user can also be automatically provided with assistance (e.g., guidelines, definitions, etc) to assist them in accomplishing this.

For example, the user could be given nine possible choices, as described below, to choose from along with accompanying descriptions of each type. Once the type of right is determined at user and/or system action 702, at user and/or system action 704 it can then be determined (e.g., automatically by the HRI management tool) whether or not the determined type of right is legally required.

To assist the reader's understanding, Table 2 provides one example of a guidance document that might be utilized to accomplish determining whether or not the determined type of right is legally required at user and/or system action 704.

TABLE 2
Example Guidance Document

```
The following types of rights are legally required:
  To be informed about their rights by being offered a Notice of
  Privacy Practices (Protocol: Notice of Privacy Practices
  Access or get copies of their own records, with narrow exceptions
  (Protocol: Access to PHI by Individuals)
  Request their record be fixed if they think there is an error
  (Protocol: Amendment)
  To ask for limitations on who has access to their information or
  who can receive it (Protocol: Restrictions)
  Finding out where their information has been sent by the facility for
  non-healthcare purposes (Protocol: Accounting of Disclosures)
  To know who at the facility will make sure their privacy rights are
  granted, or to address a complaint about a violation of their privacy
  rights (Protocol: Investigations and Sanctions)
  To have no retaliation by the facility in regards to a privacy
  complaint (Protocol: No Retaliation, No Waiver of Rights)
  To have the facility contact them at their preferred address or
  phone number (Protocol: Confidential Communications)
  Not to have to waive any of their privacy rights in order to get care
  or health insurance (Protocol: No Retaliation, No Waiver of
  Rights)
  To control the use of their identifiable information for non-
  treatment activities, such as marketing, by either requiring that
  they sign a form before their information is released, or allowing
  them to opt out of the activity (Protocol: Authorizations)
  To allow them to change their mind after signing a form to release
  their information (Protocol: Authorization Use Validity)
  Depending on the type of information, control the use or release of
  their sensitive information, even for treatment related activities
  (Protocol: Sensitive Records)
  To be informed in writing about a high risk breach of their
  information (Protocol: Breach Reporting)
  To complain to the Health and Human Service Office for Civil
  Rights if they believe any of these rights have been violated
  (Protocol: Investigations and Sanctions)
This policy demonstrates compliance with 45 CFR §145.520 (Notice) 45 CFR §145.522 (Restrictions, Confidential Communications) 45 CFR §164.524 (Access) 45 CFR §164.528 (Accounting) 45 CFR §145.526 (Amendment) 45 CFR §145.530 (Mitigation, no intimidation, no waiver of privacy rights)
```

If it is determined at user and/or system action 704 that the determined type of right is not legally required (“No”), at user and/or system action 706 the HRI request can be referred to a privacy expert (e.g., privacy officer) for a more in depth investigation and analysis. In such circumstances, a notification to make such a referral and/or contact information for such a privacy expert might be automatically presented to the user.

If it is determined at user and/or system action 704 that the determined type of right is legally required (“Yes”), at user and/or system action 708 an HRI request response algorithm of the example HRI decision framework can be selected (e.g., automatically by the HRI management tool).

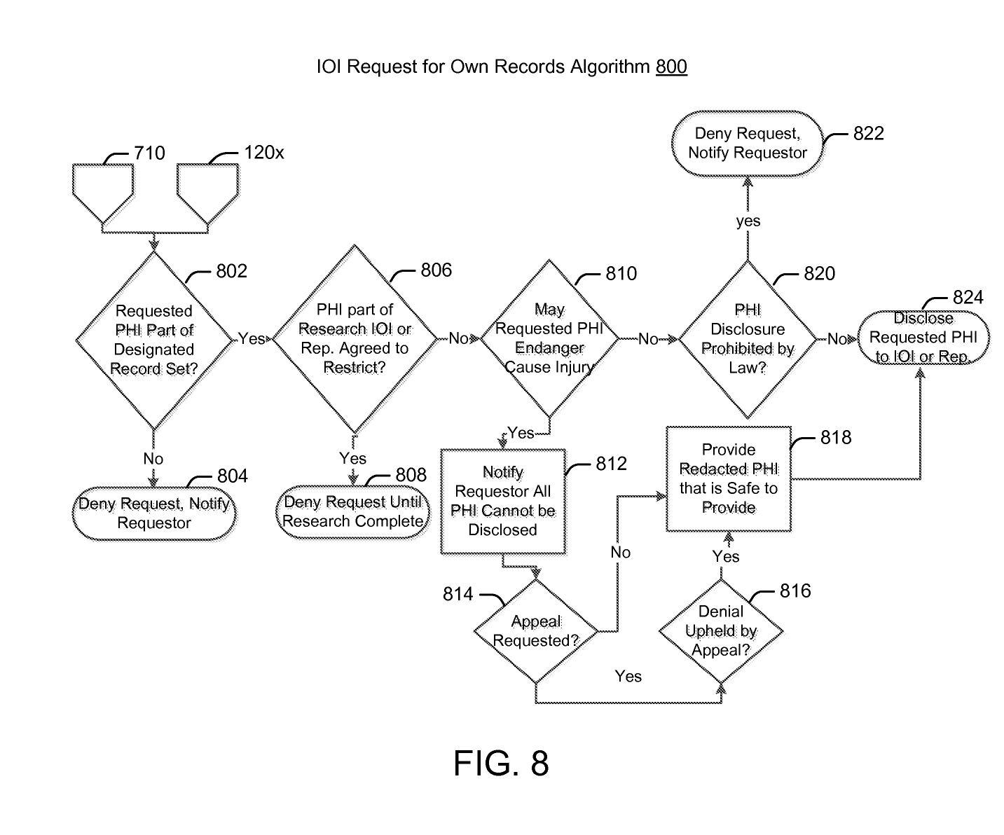

More particularly, if the determined type of right selected at user and/or system action 702 is the IOI or their representative (rep.) requesting their own PHI records, the IOI request for own records algorithm 800 can be applied and followed, as represented by algorithm identifier 710 which links to FIG. 8. The IOI request for own records algorithm 800 can provide guidance on whether or not, and how, to disclose requested PHI to the IOI or their representative.

Referring to FIG. 8, note that in this example the IOI request for own records algorithm 800 includes the following user and/or system actions: determination actions 802, 806, 810, 814, 816, and 820 (contextual information) and corresponding actions 804, 808, 812, 818, 822, and 824 (authorized response components).

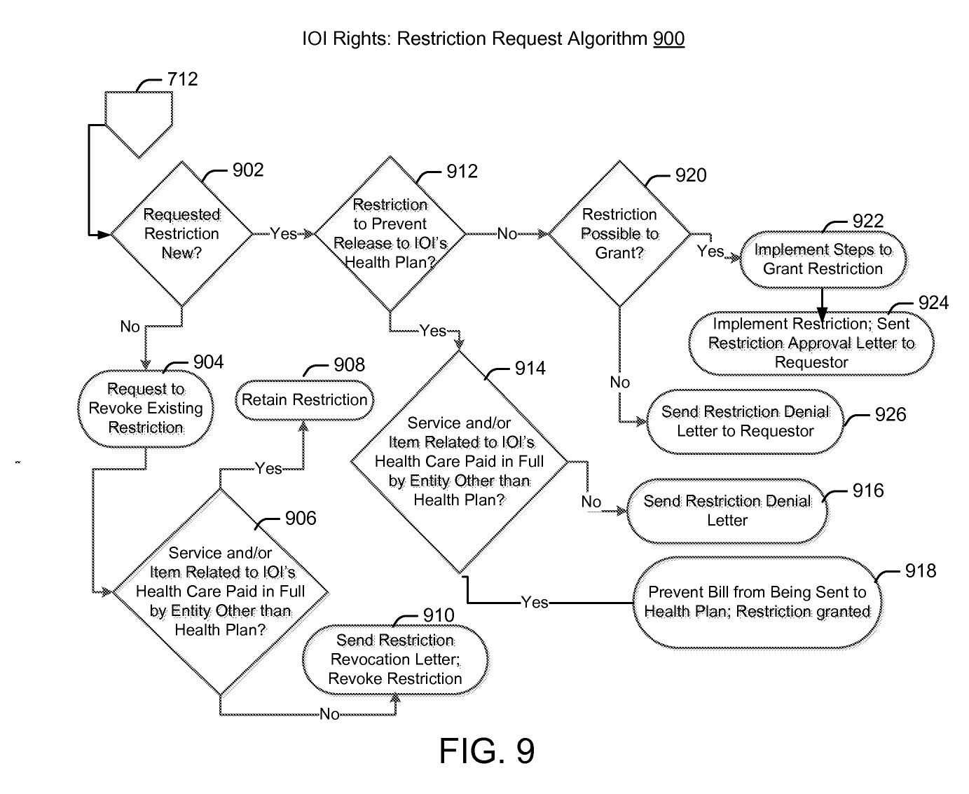

Referring back to FIG. 7, if the determined type of right selected at user and/or system action 702 is a request by the IOI or their representative to restrict the disclosure or other use of PHI associated with the IOI, the IOI rights: restriction request algorithm 900 can be applied and followed, as represented by algorithm identifier 712 which links to FIG. 9. The IOI rights: restriction request algorithm 900 can provide interactive guidance on whether or not to grant the request to restrict this disclosure request with respect the PHI's use for treatment, payment, healthcare operations, or the PHI's release to family members or friends involved in the IOI's care.

Referring to FIG. 9, note that in this example the IOI Rights: restriction request algorithm 900 includes the following user and/or system actions: determination actions 902, 906, 912, 914, and 920 (contextual information) and corresponding actions 904, 908, 910, 916, 918, 922, 924, and 926 (authorized response components).

Also note that each of these individual user and/or system actions may be performed by the user and/or at least in part automatically by the HRI management tool. For example, in at least one embodiment the determination at user and/or system action 902 as to whether or not the requested restriction is new can be made by the HRI management tool prompting the user to make this determination, and then in response by the user inputting their answer into the HRI management tool.

To assist the reader's understanding, Table 3 provides one example of a guidance document that might be utilized to accomplish one or more of the following user and/or system actions of the IOI rights: restriction request algorithm 900.

TABLE 3
Example Guidance Document

```
The following are guidelines for when an |O| requests restrictions on
their PHI:
  Restrictions will be considered for the use or disclosure of PHI for
  treatment, payment, healthcare operations, for disclosures for
  notification purposes, or to those involved in a patient’s care that
  are not treatment providers. Restrictions do not apply to
  disclosures required by law, to the Secretary of HHS to determine
  the facility’s compliance with the Privacy Rule, or to the Facility
  Directory.
  The facility must agree to a payment- or operations-related
  restriction to a health plan if the patient pays the facility in full for
  an item or service, and seeks to prevent the disclosure to a health
  plan related to the item or service. These types of restrictions
  should be referred immediately to the billing office.
  All other restriction requests should be referred to the Privacy
  Officer or Privacy Officer ’s Designee.
  If the facility Privacy Office agrees to a restriction, the restriction
  must be honored, except if the information is needed for
  emergency treatment of the individual.
  If the restricted information is provided for emergency treatment,
  the facility must ask the treating provider not to further use or
  disclose the information.
  A restriction granted by the facility, except for health plan restricted
  as outlined above, can be terminated if:
    The individual requests or agrees to the termination in
    writing, or an oral agreement is reached with the individual
    to terminate the restriction that is documented by the facility;
    or
    The facility informs the individual that future PHI collected
    about their information is not subject to the restriction in
    place on their past PHI.
  Restriction related documentation must be maintained for 6 years.
This policy demonstrates compliance with 45 CFR §164.522(a) (Restriction)
```

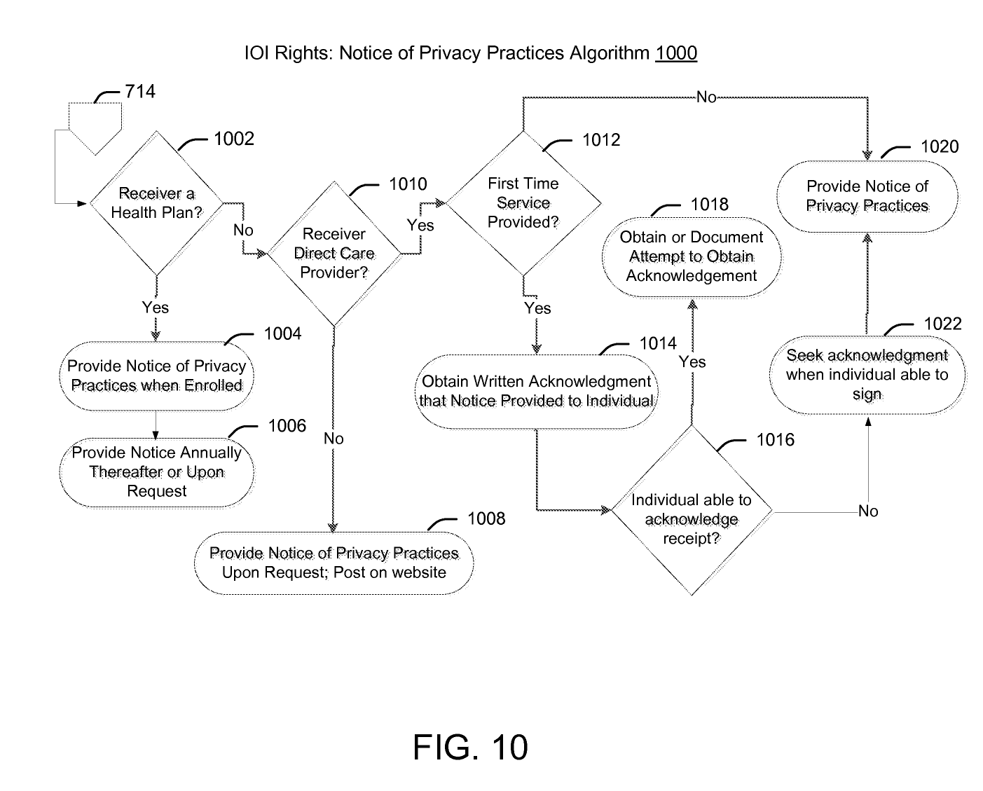

Referring again back to FIG. 7, if the determined type of right selected at user and/or system action 702 is a request by the IOI or their representative to provide a notice of privacy practices associated with the PHI requested and/or other HRI associated with the IOI, the IOI rights: notice of privacy rights algorithm 1000 can be applied and followed, as represented by algorithm identifier 714 which links to FIG. 10. The IOI rights: notice of privacy practices algorithm 1000 can provide guidance on how the notice can be maintained or otherwise managed in order to meet PHI and other applicable requirements.

Referring to FIG. 10, note that the IOI rights: notice of privacy practices algorithm 1000 includes the following user and/or system actions: determination actions 1002, 1010, 1012, and 1016 (contextual information) and corresponding actions 1004, 1006, 1008, 1014, 1018, 1020, and 1022 (authorized response components).

Also note that each of these individual user and/or system actions may be performed by the user and/or at least in part automatically by the HRI management tool. For example, in at least one embodiment the determination at user and/or system action 1002 as to whether or not the receiver (e.g., the entity receiving the HRI request that includes the requested PHI) is a health plan can be made by the HRI management tool prompting the user to make this determination, and then in response by the user inputting their answer into the HRI management tool.

To assist the reader's understanding, Table 4 provides one example of a guidance document that might be utilized to accomplish one or more of the following user and/or system actions of the IOI rights: notice of privacy practices algorithm 1000.

TABLE 4
Example Guidance Document

```
The following are guidelines for provision of a notice of privacy practices:
  The individual be offered a copy of the facility Notice of Privacy
  Practices when the first service is provided by the facility, or as
  soon as possible in an emergency treatment situation. The notice
  may be sent to the individual by email, if they so request
  Obtain a written acknowledgment if possible, of the receipt of the
  Notice, or that the Notice was offered to the individual
  If a written acknowledgment is not obtained, document the effort to
  obtain it and why it could not be obtained
  If an email delivery of the Notice fails, a paper copy must be sent
  to the individual
  In areas where the individual comes for initial service in a physical
  location at the facility, have the Notice posted in a clear and
  prominent location
  Have the ability to print or provide a paper copy of the Notice upon
  request in areas where an individual is registered for services
  Have the Notice displayed on the facility’s web site, with directions
  on how to find it easily if not on the initial page
  The facility may include other covered entities providing care at
  the facility in its Notice
  The facility may deny a Notice to an inmate of a correction
  institution
  The Privacy Office will retain copies of the current Notice, as well
  as past versions, for six years.
This policy demonstrates compliance with 45 CFR §164.520 (Notice of Privacy Practices)
```

Referring back to FIG. 7, if the determined type of right selected at user and/or system action 702 is a complaint or report of a possible PHI compliance violation (e.g., by the IOI or their representative), then the IOI rights: complaint algorithm 1100 can be applied and followed, as represented by algorithm identifier 716 which links to FIG. 11.

Referring to FIG. 11, note that at user and/or system action 1102 details about the complaint can be collected and documented. In at least embodiment, this can be accomplished by automatically providing the user with a document complaint form and/or with other assistance to assist with this task. Alternatively or additionally, at least some of the details can be collected at least in part automatically by the HRI management tool based on information that is available electronically (e.g., by an electronic complaint form submitted by the requestor). At user and/or system action 1104, an investigation can be initiated based at least in part on the collected and documented details.

To assist the reader's understanding, Table 5 provides one example of a guidance document that might be utilized to implement the user and/or system actions of the IOI rights: complaint algorithm 1100.

TABLE 5
Example Guidance Document

```
Guidance statement:
This facility will not threaten, coerce, discriminate against, or retaliate
against any individual for the exercise of their Privacy Rule rights, or for
participating in any process that the Privacy Rule defines. This facility
will also not retaliate against any individual for filing a complaint if they
believe this facility has failed to follow the Privacy Rule. This facility
will not require an individual to waive their Privacy Rule rights as a
condition of treatment or payment for treatment.
  PROCEDURE:
  A compliant or a concern from an individual that they were not
  granted their Privacy Rule rights will be referred to the facility
  Privacy Officer or designee.
  Such complaint or concerns will not be taken into account when
  decisions are made about the individual’s care or payment of that
  care.
  In order to ensure that treatment or payment of care is not
  impacted, such complaints or concerns about Privacy Rule rights
  will not be recorded in the medical or billing records.
  This facility should never ask Individuals to waive any of their
  Privacy Rule rights unless required by legal processes.
The only person in the facility who can approve an exception to
these rights is <Facility Privacy Officer>.
This guidance demonstrates compliance with 45 CFR §164.308 (Security awareness and training) 45 CFR §164.530(g) (Refraining from retaliatory acts) and 45 CFR §164.530(h) (No waiver of rights)
```

Referring back to FIG. 7, recall that in addition to the algorithm identifiers 710, 712, 714, and 716 described in detail above, additional algorithm identifiers 718, 720, 722, and 724 are also illustrated. Each of these additional algorithm identifiers can also correspond to a respective individual HRI request response algorithm that may be applied and followed based on the type that is selected at user and/or system action 702.

For example, for algorithm identifier 718 an IOI rights: confidential communication algorithm can be implemented and followed if the determined type of right selected at user and/or system action 702 is a request from the IOI or their Rep. to list alternate contact information for future HRI correspondences. For ease of discussion, this algorithm will not be described in detail.

As another example, for algorithm identifier 720 an IOI rights: amendment request algorithm can be implemented and followed if the determined type of right selected at user and/or system action 702 is a request from the IOI or their Rep. to amend their record (e.g., health medical record). For ease of discussion, this algorithm will not be described in detail.

As yet another example, for algorithm identifier 722 an IOI rights: accounting of disclosures algorithm can be implemented and followed if the determined type of right selected at user and/or system action 702 is a request for the receiver to generate an accounting of the disclosures of their PHI that have been made by the receiver. For ease of discussion, this algorithm will not be described in detail.

As still another example, for algorithm identifier 724 an IOI rights: opt out algorithm can be implemented and followed if the determined type of right selected at user and/or system action 702 is a request from the IOI or their Rep. to opt out of fundraising or remunerated marketing of third-party services that are associated with PHI about the IOI. More particularly, according to HIPAA, a covered entity may use PHI to solicit contributions from its patients. Also, the covered entity may be paid to mail informational brochures to its patients about health related products, such as for pharmaceuticals, to encourage an IOI to purchase such pharmaceuticals. However, the IOI has the right to opt out of these communications, and the covered entity is required by the HITECH law to honor this opt out demand. For ease of discussion, this algorithm will not be described in detail.

Recall from the discussion above of the initiate PHI release algorithm (illustrated in FIG. 6) that at user and/or system action 604, if the requestor's identity can be verified (“Yes”), a PHI release signpost algorithm 1200 can be applied and followed, as represented at algorithm identifier 608 which links to FIG. 12.

Referring now to FIG. 12, for purposes of this discussion, the PHI release signpost algorithm 1200 can be considered a central decision point for determining individual authorized response components when a requestor's identity can be verified.

More particularly, at user and/or system action 1202 a determination can be made as to whether or not the PHI request is from the IOI or their representative. This can be performed in any suitable way based on the verified identity of the requestor. If it is determined that the request is from the IOI or their Rep. (“Yes”), the above-described 101 request for own records algorithm 800 can be applied and followed, as represented at algorithm identifier 1204 which links to FIG. 8.

However, If it is determined that the request is not from the IOI or their Rep. (“No”), at user and/or system action 1206 a determination can be made as to whether the requestor's name can be found in the receiver's records. If it is determined that the requestor's name can be found (“Yes”), then the requestor's name and other applicable information is available and at user and/or system action 1208 the reason for the request can then be obtained. As with other contextual information, the reason can collected from the requestor by the user and/or can be collected at least in part automatically by the HRI management tool. For example, a manual and/or electronic form might be presented to the requestor, or to the user to assist them in collecting this contextual information from the requestor.

If, however, it is determined at user and/or system action 1206 that the requestor's name cannot be found in the receiver's records (“No”), then the requestor's name and other applicable information about the requestor can be entered into the receiver's records at user and/or system action 1210. The user and/or system action 1208, as described above, can then be followed.

Once the reason for the request has been obtained at user and/or system action 1208, a determination can be made at user and/or system action 1214 as to whether or not the reason can be found in a reason reference table or other suitable reference document. Such a reference document (e.g., table) can be useful in mapping an individual reason obtained from the requestor with a standard defined reason that facilitates selecting an appropriate HRI request response algorithm, as discussed further below.

To assist the reader's understanding, Table 6 provides one example of a reason reference table that might be utilized to select an appropriate HRI request reference algorithm.

TABLE 6
Example Request Reason Reference Table

| REASON FOR REQUEST | CLASSIFICATION |
|---|---|
| Personal Use | Self |
| Payment of Claim | Payment |
| Treatment | Treatment |
| Life Insurance Application | Authorization |
| Healthcare | Treatment |
| Legal | Authorization |
| FSA Documentation | Self |
| Disability Determination | Authorization |
| Continuity of care | Treatment |
| Follow up care | Treatment |
| Marketing of Services | Authorization |
| Referral to healthcare | Treatment |
| provider | |
| Compliance with court | Authorization |
| ordered treatment | |
| Research | Research |
| Friend or Relative | Authorization |
| Self | Self |
| Subpoena | Subpoena/Court Order |
| Therapy | Treatment |
| Rehabilitation | Treatment |
| Counseling | Treatment |
| Return to work status | Employer |
| New patient | Treatment |
| Health history | Treatment |
| Immunizations | Public Health |
| Establish injuries as victim | Authorization |

If it is determined at user and/or system action 1214 that reason for the PHI request cannot be found in the reason request reference table or other suitable reference document (“No”), then at user and/or system action 1216 the PHI request can be rejected for clarification and a privacy expert can be contacted to assist with this clarification. Once clarified, the clarified request can then be either found in the reason request reference table or other suitable reference document, or the reason request reference table or other suitable reference document can be amended to account for the clarified request, or the request can be rejected without further clarification.

If it is determined at user and/or system action 1214 that reason for the PHI request can be found in the reason request reference table or other suitable reference document (“Yes”), then at user and/system action 1218 an appropriate HRI request response algorithm to be applied and followed can be selected. This selection can be based on the identity of the requestor and/or the reason for the PHI request.

In this example, note that a set of possible example HRI request response algorithms 1220 can be provided from which the appropriate HRI request response algorithm to be applied and followed can be selected at user and/or system action 1218. To assist the reader's understanding, Table 7 lists (without limitation) some example HRI request response algorithms that might be included in the a set of possible example HRI request response algorithms 1220.

TABLE 7
Example HRI Request Response Algorithms

Research Request for PHI algorithm
Employer Request for PHI Algorithm
Release of PHI by Authorization Algorithm
Subpoena and Court Ordered PHI Request Algorithm
Health Oversight PHI Disclosure Algorithm
Public Health PHI Disclosure Algorithm
Clergy/Facility Directory PHI Request Algorithm
External Audit Request Algorithm
Treatment Reason PHI Request Algorithm
Payment Request for PHI Algorithm
Healthcare Operations PHI Request Algorithm
PHI Request from Law Enforcement Algorithm
Required External Agreement Before PHI Disclosure Algorithm
Organized Health Care Arrangement (OHCA) PHI Disclosure
Algorithm

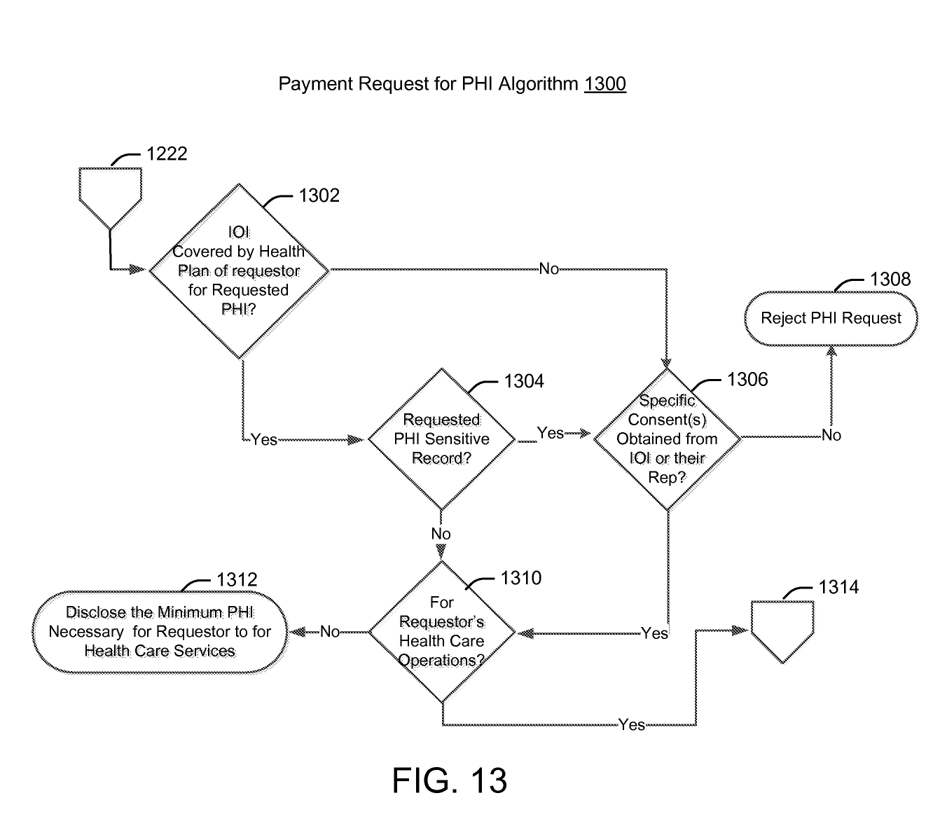

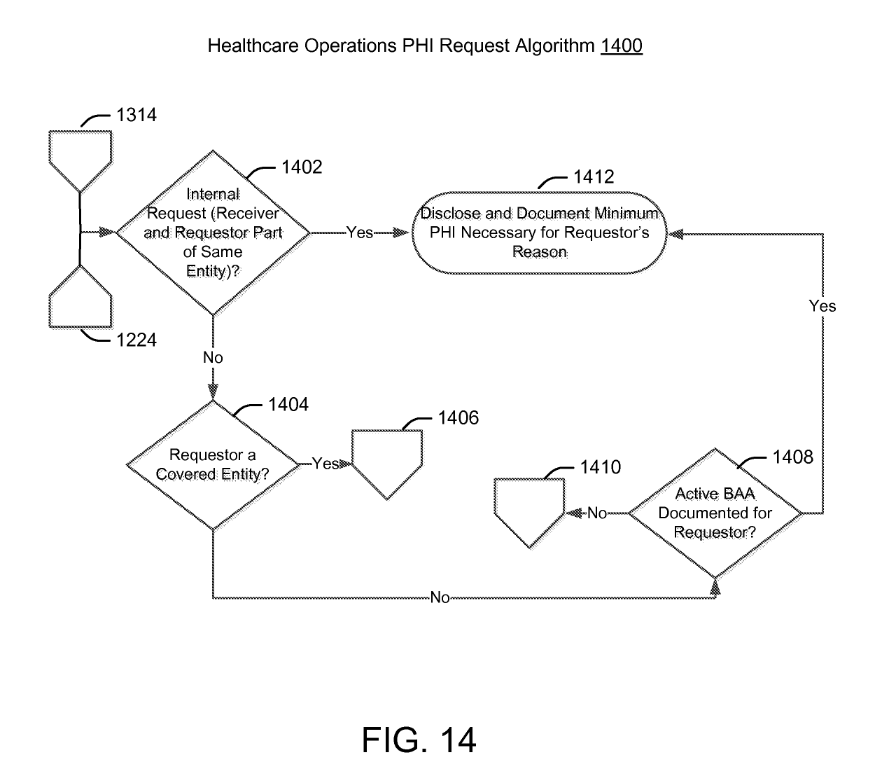

For ease of discussion, and to further assist the reader's understanding, two of the example HRI request response algorithms listed in Table 7 will be illustrated and described. These algorithms to be illustrated and described include the payment request for PHI algorithm 1300 represented at algorithm identifier 1222 which links to FIG. 13, and the healthcare operations PHI request algorithm represented at algorithm identifier 1224 which links to FIG. 14.

Referring now to FIG. 13, if the payment request for PHI algorithm 1300 is selected at user and/or system action 1218, this algorithm can be followed to compliantly disclose PHI in response to a PHI request for payment of the IOI's care they received. More particularly, at user and/or system action 1302 a determination can be made as to whether or not the IOI was covered by a health plan of the requestor for the care associated with the requested PHI.

If it is determined at user and/or system action 1302 that the IOI was covered (“Yes”), at user and/or system action 1304 it can be determined whether or not the requested PHI is a sensitive record (i.e., is sensitive). In at least one embodiment a guidance document, such as the example sensitive record PHI guidance document provided in Table 8, can be utilized by the user and/or HRI management tool to make this determination manually and/or at least in part automatically.

TABLE 8
Example Guidance Document

```
Guidance Statement:
This facility provides the above services that involve sensitive PHI.
This facility will provide the extra protection for these types of health
information as required by law, and make sure no sensitive information
is disclosed unless the requirements of law are met.
For psychotherapy notes
  The facility will only release psychotherapy notes if the
  authorization only allows for the disclosure of psychotherapy
  notes, and does not include other types of records.
  The facility will require an authorization before any psychotherapy
  notes are used or disclosed unless the use is by the originator of
  the notes for treatment of the individual; the use is by the facility
  for its own training programs; the disclosure is to defend its self in
  a legal action brought by the individual; or the use is required or
  permitted by law.
For drug and alcohol abuse treatment records received by the facility, or
generated by a facility’s program that is assigned extra protections by
federal law
  The facility will not release or re-release drug or alcohol abuse
  treatment records that identify an individual, or confirm an
  individual is receiving such treatment, unless:
    A written consent by the individual is provided that allow for
    the release
    It is for a bona fide medical emergency
    A special court order is provided
    It is for child abuse reporting, or to report a crime against a
    program or a program employee
    An external entity requesting information providing services
    has a Qualified Service Organization agreement on file
    Or as otherwise permitted by 42 CFR Part 2.
For genetic test results protected by federal and/or state law:
  Genetic Test results will not be provided to a health plan for
  underwriting or risk determination purposes, or to an employer,
  even if an authorization is provided.
  For types of diagnoses protected by state law:
  Behavioral health treatment <State and Federal Rules: Sensitive
  PHI > require <State and Federal Rules: Sensitive PHI >
  Communicable Diseases consisting of <State and Federal Rules:
  Sensitive PHI> require <State and Federal Rules: Sensitive PHI>
  A minor child’s pregnancy information requires <facility defined>
  A minor’s birth control services require <facility defined>
  Abortion related services require <facility defined>
This guidance demonstrates compliance with 45 CFR §145.508, Psychotherapy Notes; 42 CFR Part 2, Federal Drug or Alcohol Abuse Treatment record protections, Genetic Information Nondiscrimination Act of 2008 (PL 110-223)
```

If it is determined at user and/or system action 1304 that the requested PHI is a sensitive record (“Yes”), at user and/or system action 1306 it can be determined whether or not one or more specific applicable consents have been provided by the IOI or their Rep. For example, before a bill for services provided by a drug treatment program can be submitted to an IOI's health plan, the IOI must sign a consent form to allow the disclosure to the health plan. Another example is if the IOI is being treated for Human Immunodeficiency Virus Infection/Acquired Immunodeficiency Syndrome (HIV/AIDS). Some state laws require a specific consent be signed by the IOI before any information about the treatment can be disclosed to anyone, including the IOI's health plan.

If it is determined at user and/or system action 1306 that a specific applicable consent(s) has not been provided (“No”), at user and/or system action 1308 the PHI request can be rejected. However, If it is determined at user and/or system action 1306 that a specific applicable consent(s) has been provided (“Yes”), at user and/or system action 1310 a determination can be made whether or not the specific applicable consent(s) is for the requestor's health care operations, such as review of the IOI's utilization of health plan benefits or by enrolling the IOI in the health plan's disease management program.

If it is determined at user and/or system action 1310 that the specific applicable consent(s) is not for the requestor's health care operations (“No”), at user and/or system action 1312 the minimum amount of PHI that is necessary to meet the requestor's obligation to pay for the health care services provided to the IOI can be disclosed.

To assist the reader's understanding, without limitation Table 9 provides one example of a guidance document that might be utilized to determine what the minimum amount of PHI that is necessary is.

TABLE 9
Example Guidance Document

```
Guidance Statement:
  When using or disclosing Protected Health Information (PHI), this
facility will make reasonable efforts to limit the protected health
information to the minimum necessary to accomplish the intended
purpose of the use, disclosure or request of the PHI. The only times the
minimum necessary criteria are not applied by the facility are for
disclosures or requests for treatment to other healthcare providers, to
individuals about their own PHI, by an individual’s authorization, to the
Secretary of DHHS, or when the disclosure is required by law.
Guidance:
  Minimum necessary uses of PHI are implemented by this facility
  by:
    Deciding the types of workforce who need access to PHI,
    and whenever possible, restricting their access to the
    minimum necessary for their job by electronic access
    policies
    Using de-identified or limited data set information whenever
    possible for internal healthcare operations uses
    Following any recommendations by the Secretary of HHS as
    to minimum necessary uses of PHI
  Minimum necessary disclosure of PHI are implemented by this
  facility by:
    Providing the minimum necessary PHI access or
    disclosures to business associates that may be needed for
    their services
    Reviewing routine and recurring disclosures periodically,
    such as interfaces, to determine if it is the minimum
    necessary to meet the purpose of the disclosure
    Developing and using criteria to determine the minimum
    necessary PHI needed for a requested purpose, including
    following any recommendations by the Secretary of HHS
    Not providing an entire medical record unless justified as
    necessary by criteria
  Minimum necessary requests for PHI are implemented by this
  facility by:
    Restricting any requests for PHI to what is needed for the
    purpose
    Reviewing reoccurring requests or interfaces to determine if
    only necessary PHI is being received by developing and
    implement criteria by request type
    Not requesting an entire medical record unless justified by
    criteria
  The following entities/persons may be relied upon, in general, to
  request only the minimum necessary PHI:
    Public officials
    Other covered entities
    Workforce of the facility or an employee of a business
    associate of the facility if requested for a work related
    purpose
    A researcher who is requesting a waiver of authorization an
    certifies the information requested in the minimum
    necessary for the research
This guidance demonstrates compliance with 45 CFR §164.502(b) and §164.514(d) (Minimum Necessary)
```

If it is determined at user and/or system action 1310 that the specific applicable disclosure is for the requestor's health care operations (e.g., as utilization review or disease management) (“Yes”), an example healthcare operations PHI request algorithm 1400 can be followed at algorithm identifier 1314, which links to FIG. 14.

Recall that alternatively to, or in addition to, being identified by algorithm identifier 1314, the healthcare operations PHI request algorithm 1400 can also be identified by algorithm identifier 1224 shown in FIG. 12. Accordingly, in some circumstances, the healthcare operations PHI request algorithm 1400 can be selected, applied, and followed at user and/system action 1218.

Referring back to and/or system action 1304, if it determined that the requested PHI is a not a sensitive record (“No”), the determination at user and/or system action 1310 can be made, as described above.

Referring now to FIG. 14, at user and/or system action 1402 a determination can be made as whether or not the PHI request is an internal request. An internal request can be considered a request about an IOI from a PHI requestor that is part of the same entity (i.e., covered entity) as the receiver. For example, the requestor might be a quality assessment/quality improvement employee of a hospital that is a covered entity and the receiver might be the medical records department of the hospital.

If it is determined at user and/or system action 1402 that the request is an internal request (“No”), a determination can be made at user and/or system action 1404 whether or not the requestor is a covered entity that is subject to PHI requirements. If it is determined that the requestor is a covered entity (“Yes”), an organized health care arrangement (OHCA) PHI disclosure algorithm can be applied and followed, as illustrated by algorithm indicator 1406. For ease of discussion, this algorithm will not be described in detail.

If, however, it is determined at user and/or system action 1404 that the requestor is not a covered entity (“No”), a determination can be made at user and/or system action 1408 whether or not an active business associate agreement (BAA) between the requestor and the receiver is documented (i.e., in place). If it is determined that such a BAA is not documented (“No”), then a required external agreement before PHI disclosure algorithm can be applied and followed, as illustrated by algorithm indicator 1410. For ease of discussion, this algorithm will not be described in detail.

If however, it is determined at user and/or system action 1408 that such a BAA is documented (“Yes”), at user and/or system action 1412 the minimum amount of PHI that is necessary to meet the requestor's reason for the PHI request can be disclosed and documented.

Referring back to user and/or system action 1402, if it is determined that the request is an internal request (“Yes”), at user and/or system action 1412 the minimum amount of PHI that is necessary to meet the requestor's reason for the PHI request can be disclosed and documented.

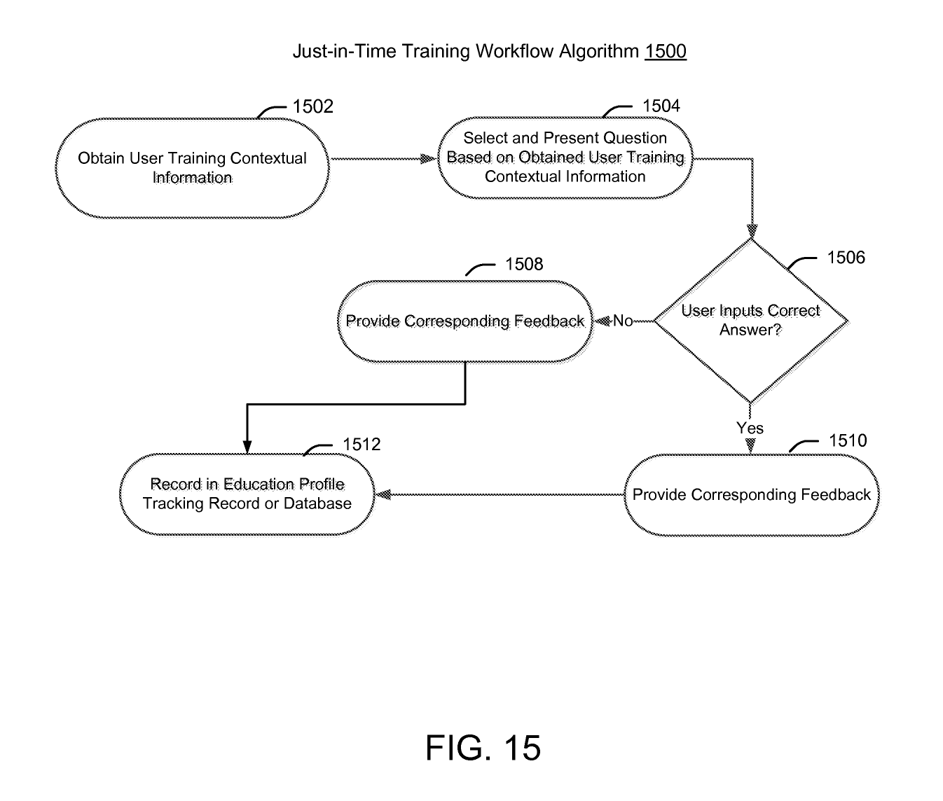

Recall that in at least one embodiment, the HRI management tool can be configured to utilize the HRI decision framework to provide HRI training in a timely (e.g., just-in-time) and relevant manner. To facilitate the readers understanding of how such training might be provided, FIG. 15 illustrates an example HRI request response algorithm, namely just-in-time training workflow algorithm 1500, that might be included in the example HRI decision framework described herein.

Referring to FIG. 15, at user and/or system action 1502, user training contextual information can be obtained. In at least one embodiment, this user training contextual information can include information about a user's (e.g., trainee's) previous training and/or interaction with the HRI tool. Without limitation, this information might include the user's previous training record or profile, such a their test taking history (e.g., previous answers, previous HRI response request algorithms associated with the test taking history, etc.) for instance. Alternatively or additionally, this information might describe the user's interaction with the HRI management tool might include data identifying one or more current and/or previous HRI request response algorithms associated with the interaction.

At user and/or system action 1504, one or more questions can be selected and presented to the user based on the obtained user training contextual information. For example, in at least one embodiment the user might be asked questions about a real or mock HRI request and/or other types of questions intended to test the user's knowledge and provide practical training about HRI compliance, including about a particular request scenario. Alternatively or additionally, the user can be exposed to individual HRI request response algorithms, or protocols, of the HRI decision framework and asked questions (e.g., multiple choice, etc.) intended to test the user's knowledge of an individual request response algorithm or protocol.

At user and/or system action 1504, a determination can be made as to whether or not the user input a correct answer to the question selected and presented at user and/or system action 1506. If it is determined at user and/or system action 1504 that the user did not input the correct answer (“No”), corresponding feedback can be provided at user and/or system action 1508.

For example, if the user did not input an answer (e.g., no answer input received after a determined period of time from when the question was presented), the corresponding feedback might indicate that an answer was not received. As another example, if an incorrect answer was received, the corresponding feedback might indicate this, present the correct answer, and/or refer the user to a reference for review (e.g., to another appropriate HRI request response algorithm).

If it is determined at user and/or system action 1504 that the user did input the correct answer (“Yes”), corresponding feedback can be provided at user and/or system action 1510. For example, the corresponding feedback might confirm to the user that they input the correct answer.

At user and/or system action 1512, the inputted answer from the user (if any) and/or the corresponding feedback presented at user and/or system action 1508 or 1512 can be documented (e.g., recorded in a education profile for the user and/or other manner).

To assist the reader's understanding, Table 10 provides some example questions and answers that might be associated with the example guidance document provided in Table 9 and might be utilized to determine the user's understanding of the content of that example guidance document.

TABLE 10
Just in Time Questions Example

```
Minimum Necessary Protocol Questions
Q1 What is considered a reasonable way to limit uses of protected
health information to the minimum necessary?
  a. By only allowing management to access the information
  b. By providing only a limited data set when possible
  c. Keeping information only on paper
  Q1 ANSWER: b
Q2 Who are we allowed to trust to only ask for the minimum necessary
information?
  a. Public officials
  b. Subcontractors
  c. Life insurers
  Q2 ANSWER: a
Q3 In what circumstances is the facility required to apply minimum
necessary standards?
  a. Accesses to records by workforce, other than treatment
  b. When disclosing de-identified data sets
  c. Only when the information has an approved restriction on file by
  the individual
  Q3 ANSWER: a
```

### CONCLUSION

Methods, devices, systems, etc., pertaining to heath-related information (HRI) management techniques are described for handling individual requests for HRI in a timely and compliant manner, and/or for providing HRI training in a timely and relevant manner. However, it is to be understood that the subject matter defined in the appended claims is not necessarily limited to the specific features or acts described. Rather, the specific features and acts are disclosed as exemplary forms for implementing the claimed methods, devices, systems, etc.

1. A method comprising:
receiving a request for health-related information (HRI);
responsive to receiving the request, obtaining contextual information associated with the request;
utilizing a decision framework of one or more HRI request response algorithms to determine an authorized response to the request based on one or both of: the contextual information or a protected HRI requirement.

2. The method of claim 1, wherein some or all of the HRI comprises protected health information (PHI) under the Health Insurance Portability and Accountability Act of 1996 (HIPAA).

3. The method of claim 1, wherein the protected HRI requirement comprises a PHI requirement under HIPAA.

4. The method of claim 1, wherein to determine the authorized response comprises one or both of:
determining an authorized portion to disclose in response to the request; or
determining an action to be taken in response to the request.

5. The method of claim 4, wherein the authorized portion does not include the requested HRI.

6. The method of claim 4, wherein the authorized portion comprises some or all of the requested HRI.

7. The method of claim 4, wherein the action comprises documenting at least some of the contextual information or the authorized portion.

8. The method of claim 1, wherein obtaining the contextual information comprises automatically traversing one or more decision pathways of the one or more HRI request response algorithms.

9. The method of claim 1, wherein utilizing the decision framework comprises automatically traversing one or more decision pathways of the one or more HRI request response algorithms based on the contextual information.

10. One or more computer-readable storage media having instructions stored thereon that, when executed by a computing device, cause the computing device to perform acts comprising:
responsive to receiving a request for health-related information (HRI) associated with an individual, collecting contextual information associated with the request;
based at least in part on the collected contextual information, identifying and collecting other contextual information associated with the request at least in part by traversing one or more decision pathways of one or more HRI request response algorithms; and
determining an authorized response based on one or both of: the contextual information or other collected contextual information.

11. The one or more computer-readable storage media of claim 10, wherein collecting the contextual information or collecting the other contextual information is performed at least in part by a management tool configured to utilize a decision framework.

12. The one or more computer-readable storage media of claim 11, wherein the decision framework comprises the one or more HRI request response algorithms.

13. The one or more computer-readable storage media of claim 10, wherein traversing the one or more decision pathways comprises:
determining a type of the request; and
based on the type of the request, applying a corresponding individual HRI request response algorithm.

14. The one or more computer-readable storage media of claim 10, wherein the contextual information or other contextual information comprises information about at least one of: a requestor of the request, the request, the HRI, the individual, or a receiver of the request.

15. The one or more computer-readable storage media of claim 10, wherein the identifying and collecting further comprise interactively guiding a user to at least one of:
request the contextual information or other contextual information;
collect the contextual information or other contextual information; or
input the contextual information or other contextual information.

16. A system, comprising:
at least one processor;
a health-related information (HRI) decision framework comprising one or more HRI request response algorithms; and
a HRI management tool comprising:
a contextual information module configured to utilize the HRI decision framework to obtain contextual information applicable to determining an authorized response to a request for HRI; and
a response module configured to utilize the HRI decision framework to determine the authorized response to the request based on the contextual information.

17. The system of claim 16, wherein some or all of the HRI comprises protected health information (PHI) under the Health Insurance Portability and Accountability Act of 1996 (HIPAA).

18. The system of claim 16, wherein the contextual information module is further configured to obtain the contextual information at least in part by traversing one or more decision pathways of one or more HRI request response algorithms.

19. The system of claim 16, wherein the response module is further configured to determine the authorized response at least in part by traversing one or more decision pathways of one or more HRI request response algorithms.

20. The system of claim 16, wherein the HRI management tool further comprises a HRI training module configured to interactively test a user about PHI protections by traversing the one or more decision pathways of one or more HRI request response algorithms.
